(19) United States
(12) Patent Application Publication
(10) Pub. No.: US 2024/0193509 A1
(43) Pub. Date: Jun. 13, 2024

(54) SYSTEMS AND METHODS FOR GENERATING WORK SHIFT SCHEDULES

(71) Applicant: Mariah Bowles, Florissant, MO (US)

(72) Inventor: Mariah Bowles, Florissant, MO (US)

(21) Appl. No.: 17/976,098

(22) Filed: Oct. 28, 2022

Related U.S. Application Data
(60) Provisional application No. 63/272,788, filed on Oct. 28, 2021.

(51) Int. Cl. G06Q 10/0631

(52) U.S. Cl. CPC G06Q 10/063118; G06Q 10/063112; G06Q 10/063116

(57) ABSTRACT

Systems and methods for generating work shift schedules include sending a plurality of unassigned work shifts to shift workers, receiving shift selections based on the plurality of unassigned work shifts from the shift workers, approving at least one of the shift selections if the shift selection meets at least one selection parameter, and generating a work shift schedule based on the shift selections.

### CROSS-REFERENCE TO RELATED APPLICATION

This application claims priority to U.S. Provisional Patent Application No. 63/272,788, filed on Oct. 28, 2021, the entire content and disclosure of which is incorporated by reference in its entirety.

### BACKGROUND

The field of the disclosure relates generally to systems and methods for scheduling shift work, and, more specifically, to a system and method that incorporates worker inputs and administrator requirements to schedule shift work.

Shift workers (e.g., employees, independent contractors, etc.) may be assigned work to perform during a designated work period (i.e., a work shift). The work shifts may include a designated number of hours, designated tasks or routes, a performance quota, or any other parameters of work that can be assigned. For example, a calendar period workweek may be divided into a number of work shifts that are assigned to the shift workers. The shift workers work their assigned work shifts and are paid based on the number of hours or work shifts completed. Work shifts allow businesses to continuously rotate shift workers that are performing routine tasks and enable the businesses to operate efficiently.

Typically, a scheduler or other responsible person for the business (e.g., an administrator) generates work shift schedules. However, each work shift schedule may take several hours by one or more schedulers to generate. In addition, shift workers may be unhappy or feel that the work shift schedule and the shifts assigned by the schedulers are arbitrary or unfair. Moreover, the work shift schedule may not comply with internal business policies or employment regulations due to human errors or incorrect information during the process. Also, the work shift schedule may not efficiently assign resources and may unnecessarily increase the operating cost of the business.

Therefore, a system is needed that generates work shift schedules efficiently based on business requirements and shift worker inputs. In addition, the system should ensure compliance with employment regulations and internal business policies.

### BRIEF DESCRIPTION

In one aspect, a system for generating work shift schedules includes a processor and a memory communicatively coupled to the processor. The memory stores instructions that, when executed by the processor, perform operations comprising receiving a schedule request, and determining a plurality of unassigned work shifts based on the schedule request. Each shift of the plurality of unassigned work shifts includes assignment criteria. The operations also comprise determining a plurality of shift workers from a database of shift workers that are eligible to work the plurality of unassigned work shifts based on the assignment criteria of the unassigned work shifts and a characteristic associated with the shift workers in the database, providing a notification relating to the plurality of unassigned work shifts to the eligible shift workers, providing a menu of available shift selections for each eligible shift worker, and receiving at least one shift selection from the eligible shift workers. The operations further comprise approving the shift selection if the shift selection meets at least one selection parameter and outputting a work shift schedule based on the shift selection. The work shift schedule includes at least one assigned work shift. The operations also comprise providing a notification of the outputted work shift schedule to an administrator, and providing a notification of the outputted work shift schedule to the shift workers.

In another aspect, a method for generating work shift schedules includes receiving a plurality of unassigned work shifts. Each shift of the plurality of unassigned work shifts includes assignment criteria. The method also includes comparing the assignment criteria to at least one characteristic associated with shift workers in a database, determining a plurality of shift workers from the database that are eligible to work the plurality of unassigned work shifts based on the assignment criteria of the unassigned work shifts and the characteristic associated with the shift workers in the database, and providing a notification relating to the plurality of unassigned work shifts to the eligible shift workers. The method further includes providing a menu of available shift selections for each eligible shift worker, receiving at least one shift selection from the eligible shift workers, approving the shift selection if the shift selection meets at least one selection parameter, and outputting a work shift schedule based on the shift selection. The work shift schedule includes at least one assigned work shift. The method further includes providing a notification of the outputted work shift schedule to an administrator, and providing a notification of the outputted work shift schedule to the shift workers.

In yet another aspect, a system includes a processor, and a memory communicatively coupled to the processor. The memory stores instructions that, when executed by the processor, perform operations comprising sending a plurality of unassigned work shifts to shift workers. Each shift of the plurality of unassigned work shifts includes assignment criteria. The operations further comprise providing a menu of available shift selections for the unassigned work shifts for each shift worker, receiving shift selections based on the plurality of unassigned work shifts from the shift workers, approving at least one of the shift selections if the shift selection meets at least one selection parameter, and generating a work shift schedule determined based on the shift selections. The work shift schedule includes at least one work shift that is assigned to the shift worker. The operations also include outputting the work shift schedule.

### BRIEF DESCRIPTION OF THE DRAWINGS

FIGS. 1A-1E illustrate an example system for generating work shift schedules, the system including a scheduling system in communicative connection with at least one shift worker device and an administrator device.

FIG. 2 illustrates an example database of shift workers for use with the system shown in FIGS. 1A-1E.

FIG. 3 illustrates an initial work shift schedule including unassigned work shifts.

FIG. 4 illustrates a table of shift selections made by a shift worker based on the initial work shift schedule shown in FIG. 3.

FIG. 5 illustrates a work shift schedule including unassigned work shifts and assigned work shifts, based on the initial work shift schedule shown in FIG. 3 and the shift selections shown in FIG. 4.

FIG. 6 illustrates a final work shift schedule including assigned work shifts, based on the initial work shift schedule shown in FIG. 3 and the shift selections shown in FIG. 4.

FIG. 7 illustrates a flow diagram of an example method of operating a computer system for generating work shift schedules, such as the system shown in FIG. 1.

FIG. 8 illustrates an example computing device.

FIGS. 9A-9C illustrate an example embodiment of a system for generating work shift schedules.

FIG. 10 illustrates an example page of a worker interface of the system shown in FIGS. 9A-9C.

FIGS. 11A-11C illustrate a user interface for use with the system shown in FIGS. 9A-9C.

FIG. 12 illustrates an example work request interface for use with the system shown in FIGS. 9A-9C.

FIG. 13 illustrates a published scheduling request.

FIG. 14 illustrates an individual schedule request for a shift worker.

FIG. 15 illustrates a selection interface for the shift workers to submit shift selections.

FIG. 16 illustrates an example shift worker schedule generated based on the scheduling request and the selections of the shift workers.

FIG. 17 illustrates an example time card showing actual worked hours for a shift worker.

FIG. 18 illustrates an example incentive time card showing bonus hours added to actual time worked.

### DETAILED DESCRIPTION

As used herein, an element or step recited in the singular and preceded with the word “a” or “an” should be understood as not excluding plural elements or steps, unless such exclusion is explicitly recited. Furthermore, references to “example” or “one implementation” of the present disclosure are not intended to be interpreted as excluding the existence of additional implementations that also incorporate the recited features.

As used herein, the term “non-transitory computer-readable media” is intended to be representative of any tangible computer-based device implemented in any method of technology for short-term and long-term storage of information, such as, computer-readable instructions, data structures, program modules and sub-modules, or other data in any device. Therefore, the methods described herein may be encoded as executable instructions embodied in a tangible, non-transitory, computer-readable medium, including, without limitation, a storage device and/or a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including without limitation, volatile and non-volatile media, and removable and non-removable media such as firmware, physical and virtual storage, CD-ROMS, DVDs, and any other digital source such as a network or the Internet, as well as yet to be developed digital means, with the sole exception being transitory, propagating signal.

The present disclosure provides systems and methods for generating work shift schedules. The system includes an administrator device and a shift worker device. The shift worker device receives inputs from the shift workers and provides automatic notifications for the shift workers. The administrator device receives inputs related to unassigned work shifts and selection parameters. The system facilitates shift workers directly selecting and automatically being assigned to unassigned work shifts. An administrator is able to control selection parameters and criteria of the unassigned work shifts. Also, the system ensures compliance with internal policies and regulations of governing bodies and reduces overtime and/or uneven distribution of hours. For example, an administrator reviews a plurality of unassigned work shifts for an upcoming work period and releases the unassigned work shifts for the shift workers to select. The system receives shift selections directly from the shift workers and determines a work shift schedule based on selection parameters, the characteristics of the shift workers, and/or criteria of the shifts. The system automatically sends the work shift schedule to the shift workers and/or the administrator. In addition, the system can automatically generate reports and ensure compliance with employment regulations.

As a result, the system simplifies the process for scheduling shift work and reduces the amount of time for administrators to gather, input, and balance requests and requirements for shift work. Also, the system reduces conflicts caused by shift work scheduling and ensures compliance with scheduling requirements. In addition, the system improves shift worker satisfaction because workers are able to directly select their shifts. Moreover, the system facilitates resource leveling and reduces cost overages due to overtime or improper balancing of shift workers hours.

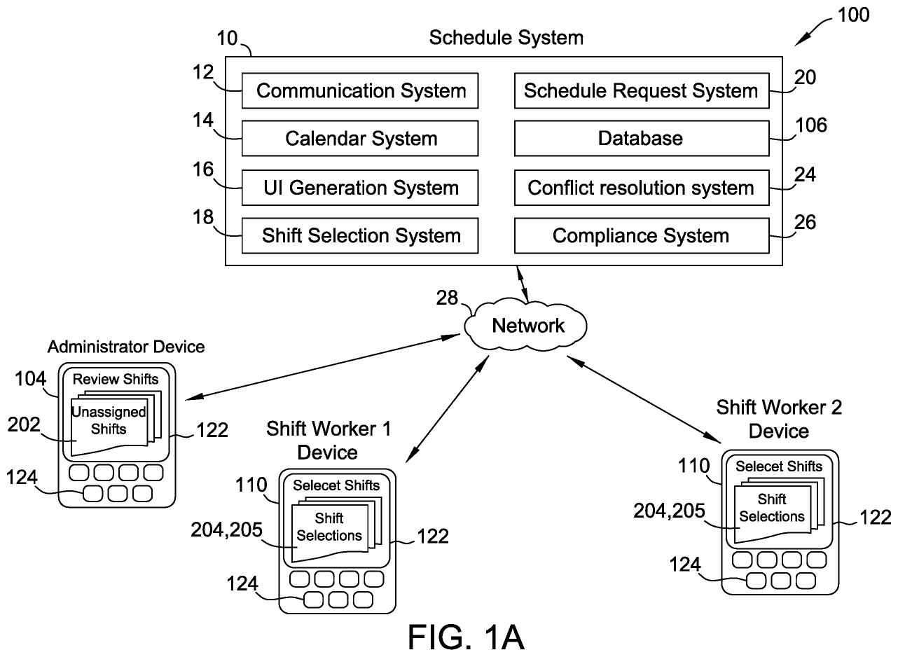

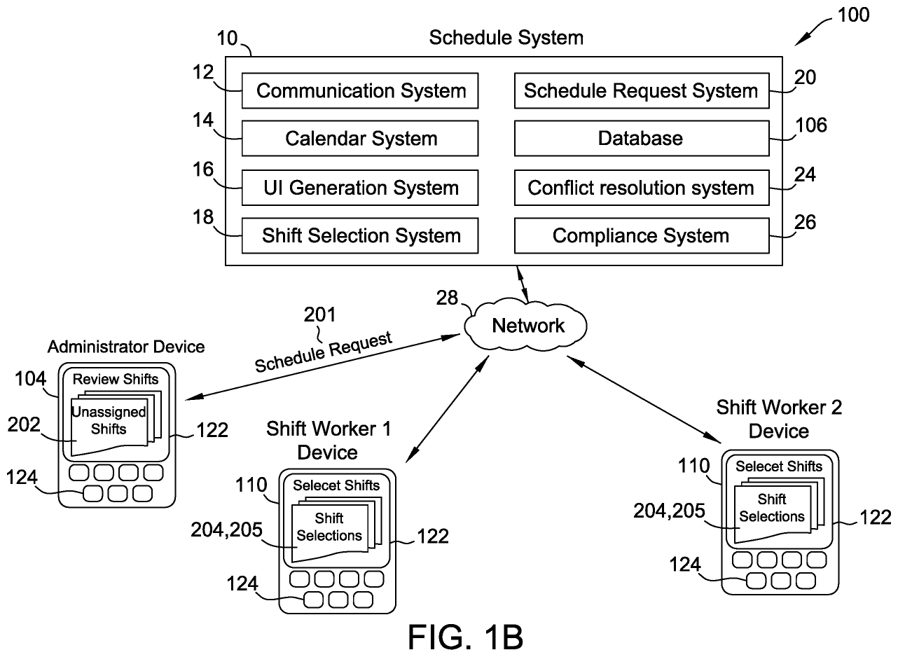

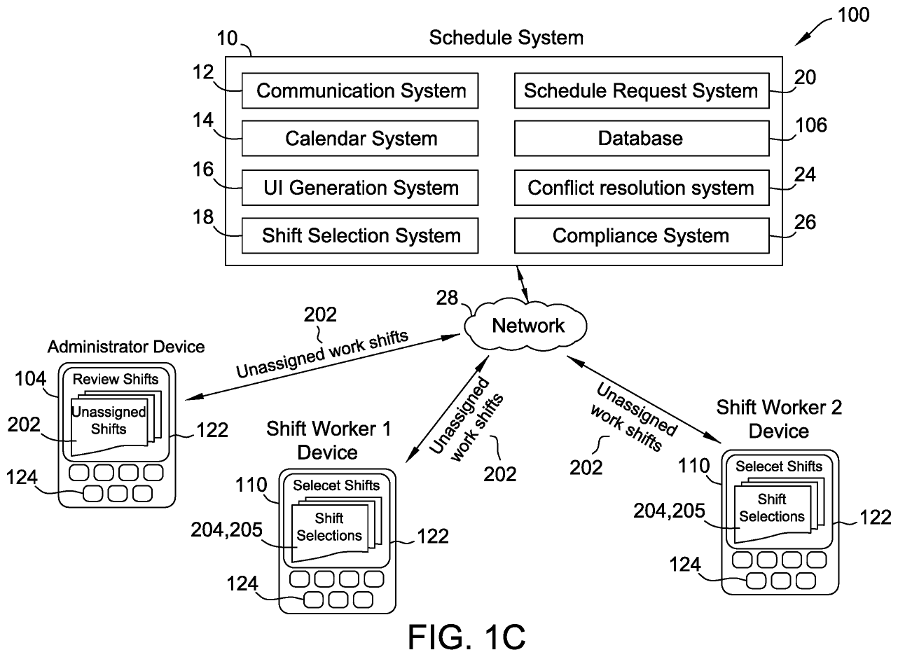

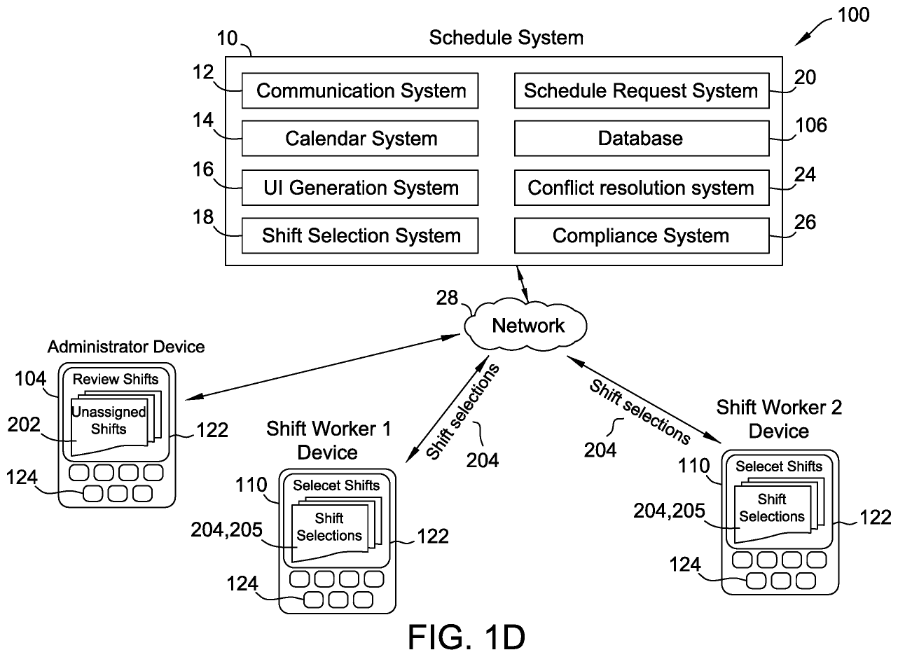

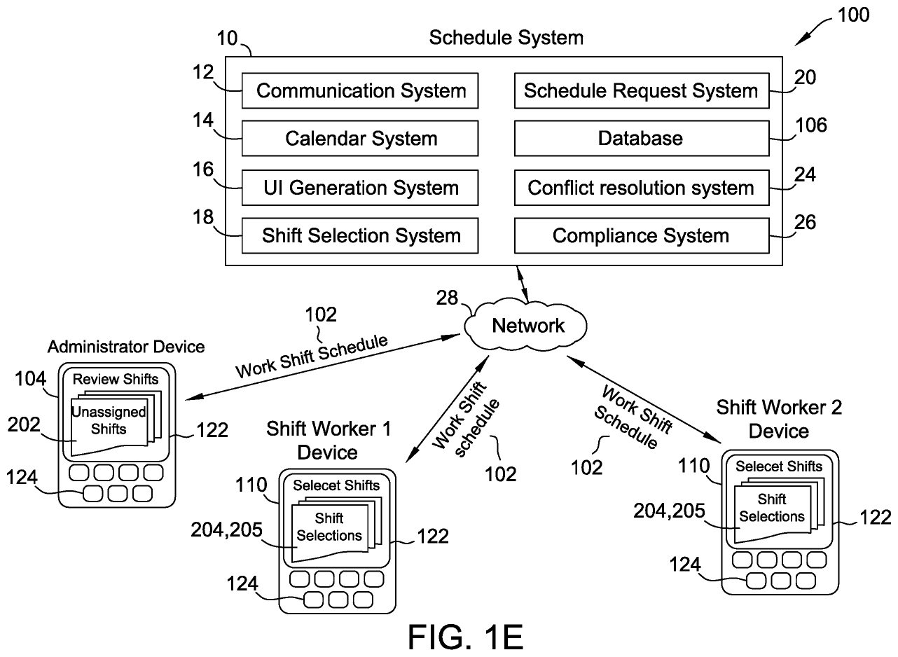

FIGS. 1A-IE illustrate an example system 100 for generating work shift schedules 102. The system 100 includes a scheduling system 10, an administrator device 104, a database 106, and a shift worker device 110. The scheduling system 10 includes a communication system 12, a calendar system 14, a user-interface (UI) generation system 16, a shift selection system 18, a schedule request system 20, at least one database 106, a conflict resolution system 24, and a compliance system 26. The scheduling system 10 may be communicatively coupled to the administrator device 104 and/or the shift worker devices 110 via a network 28. Although a network 28 is specifically shown and described, the scheduling system 10 may be communicatively coupled to the administrator device 104 and/or to the shift worker devices 110 through various communication protocols including, but not limited to, Bluetooth, near-field communication, or other wireless (or wired) communication protocols.

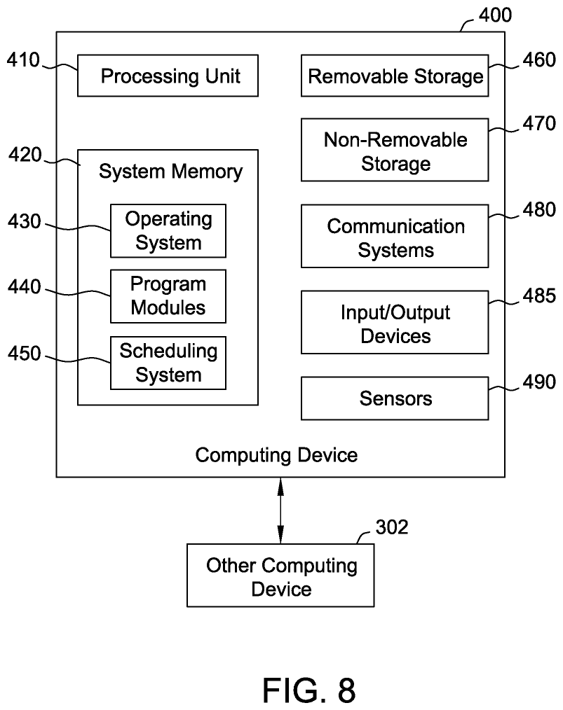

Additionally, although the scheduling system 10, the administrator device 104 and the shift worker devices 110 are shown as being separate from each other, one or more of the scheduling system 10, the administrator device 104, and/or the shift worker devices 110 may be part of the same device or otherwise integrated together. For example, any of the scheduling system 10, the administrator device 104, and/or the shift worker devices 110 may be incorporated into the computing device 400 (shown in FIG. 8). The system 100 may include any number of computing devices 400.

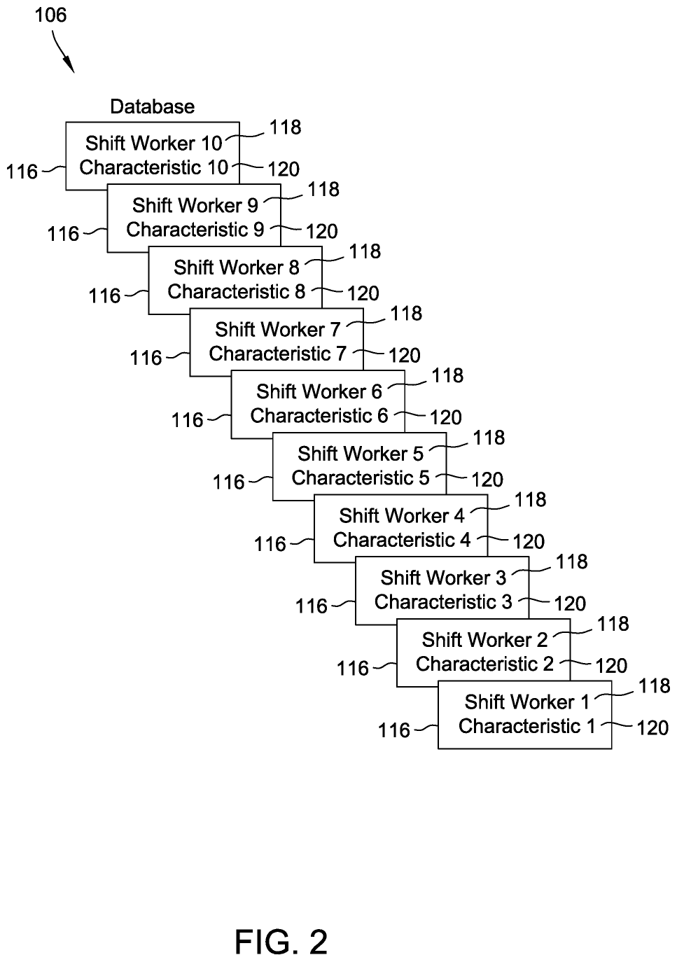

FIG. 2 illustrates an example database 106 for use with the system 100. The database 106 includes a plurality of shift worker files 116. For example, each shift worker file 116 includes a shift worker 118 and a characteristic 120 associated with the shift worker. For example, the characteristic 120 may include a name, a full-time or part-time designation, an experience level, a performance rating, a limit on a number of shifts, a priority ranking, a trainee designation, and/or a restriction on which shifts can be selected by the shift worker. The shift worker files 116 may be provided and/or maintained by a business, a hiring service, and/or the shift workers. The shift workers 118 may include employees of a business, independent contractors, employees of a hiring service, freelance workers, consultants, and/or any other workers. Confidential information of the shift workers 118 and/or the business may be protected because the information is maintained in the database 106 and access to selected information may be restricted from the administrators and/or the shift workers. For example, the scheduling system 10 retrieves the information from the database 106 such as characteristics associated with the shift workers 118 and can automatically make determinations such as which shifts the shift worker is eligible for without business personnel such as a scheduler having access to the information.

Referring to FIG. 1A, the administrator device 104 and the shift worker device 110 each include a display device 122 and an input device 124. In some embodiments, the input device 124 includes a keyboard, a computer pointer device, a touch screen, a microphone, a camera, and/or any other suitable input device. The input device 124 may be incorporated into a computing device (e.g., the computing device 400 shown in FIG. 8) that includes a processor and/or the display device 122. In other embodiments, the input device 124 may be located remotely from the computing device 400 and/or incorporated into a computing device that communicates with the computing device 400 using a computer network. For example, in some embodiments, the input device 124 is included on a mobile computing device (e.g., a smartphone or a tablet computing device).

In some embodiments, the administrator device 104 and/or the shift worker device 110 require user authentication. For example, the devices 104, 110 may require a password, a fingerprint, a verbal cue, an answer to a security question, two factor authentication, a security token, and/or any other suitable authentication means.

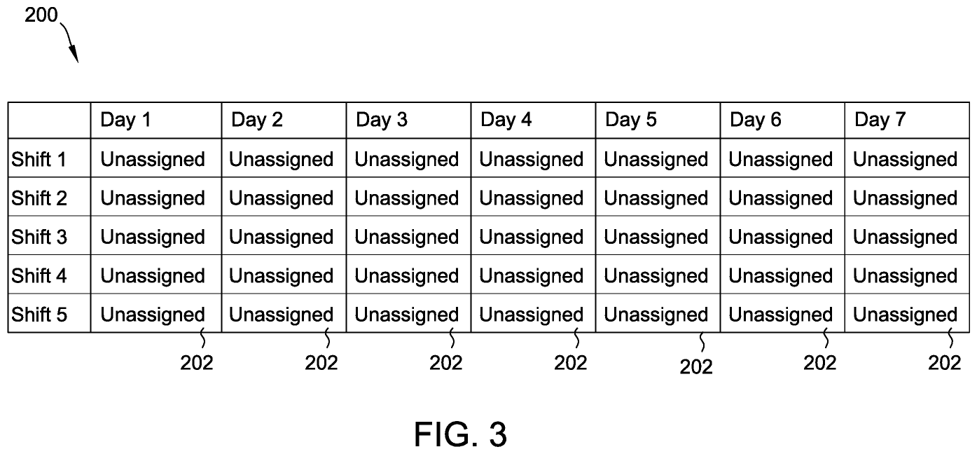

With reference to FIGS. 1A-1E and 3, the schedule request system 20 is configured receive input from an administrator entered via the input device 124 of the administrator device 104 and generate unassigned work shifts 202 for the initial work shift schedule 200. In some embodiments, the UI generation system 16 provides a user interface for the administrator device 104. For example, the administrator may submit a schedule request 201 and the scheduling system 10 generates the initial work shift schedule 200 based on the schedule request. The initial work shift schedule 200 includes a plurality of unassigned work shifts 202 generated by the schedule request system 20. For example, the administrator may review, select, and/or input the unassigned work shifts 202 for a calendar period (e.g., a workday, a workweek, a month, a year, etc.). The calendar period may be determined and tracked by the calendar system 14. The calendar system 14 correlates the unassigned work shifts 202 to the calendar period. The work shift schedule 200 illustrated in FIG. 3 is for a workweek which includes 7 days. For example, the workweek may include 5 weekdays and 2 weekend days. Shift workers with a full-time designation may be required to select, for example, three shifts on weekdays and one shift on a weekend day. In addition, the shift workers with a full-time designation may be required to select three shifts on weekdays and at least two additional shifts on a weekday or a weekend day if a selection parameter is set to require overtime for full-time shift workers. In other embodiments, the work shift schedule 200 is for a calendar period including more or less than 7 days (e.g., 1 day, 5 days, 10 days, 14 days, 30 days, etc.). In further embodiments, the work shift schedule 200 includes scheduling units other than days.

In some embodiments, the calendar system 14 determines the number of unassigned work shifts 202 for the calendar period based on historical data, performance requirements, workplace orders, calendar restraints, hours requirements, and/or any other suitable parameters. Each unassigned work shift 202 may include a set number of hours, a route, a production quota, or any other work unit that can be assigned to a shift worker. The administrator may increase or decrease the number of unassigned work shifts 202 and/or modify characteristics of the work shifts 202 (e.g., the number of hours in each shift, the associated pay for the work shift). The calendar system 14 sorts the unassigned work shifts 202 for the selected calendar period and generates the work shift schedule 200.

In the example, each unassigned work shift 202 includes assignment criteria. For example, the assignment criteria includes at least one of a full-time or part-time designation requirement, an experience level requirement, or a performance rating requirement. The assignment criteria must be met for the unassigned work shift 202 to be selected by a shift worker. For example, a shift worker must have the appropriate experience level or performance rating to be assigned an unassigned work shift that requires a minimum experience level or minimum performance rating. In some embodiments, at least some work shifts 202 require a full-time or part time designation for the shift work worker to be assigned the work shift. The assignment criteria for each unassigned work shift 202 may be input via the input device 124 and/or determined by the shift selection system 18 based on a calendar restraint, a characteristic of the work shift, performance requirements, workplace orders, or any other suitable parameter.

The shift selection system 18 is configured to determine a plurality of shift workers 118 from the database 106 that are eligible to work the plurality of unassigned work shifts 202 based on the assignment criteria of the unassigned work shifts 202 and the characteristics 120 associated with the shift workers in the database. For example, the shift selection system 18 determines if the unassigned work shifts 202 have assignment criteria that would include or exclude some of the shift workers 118. For example, the shift selection system 18 retrieves from the database 106, or receives from the shift worker devices 110 and/or the administrator device 104, a list of shift workers 118 with a full-time designation if some of the work shifts require a full-time designation. In addition, the shift workers 118 may be characterized as trainees and the shift workers 118 listed as trainees may not be eligible for some shifts. The administrator may review and/or select characteristics for the shift workers such as a trainee designation before the scheduling system 10 sends the work shifts to the shift workers. The shift selection system 18 generates a list of the shift workers 118 for each work shift 202 and then generates a cumulative list of the shift workers eligible for shifts in the work shift schedule 200.

The communication system 12 provides a notification for the eligible shift workers 118 relating to the plurality of unassigned work shifts 202. For example, the communication system 12 sends an electronic communication (e.g., an email, text message, or other electronic communication) via the shift worker device 110 or another interface to the shift workers 118 alerting the shift workers 118 that the work shift schedule 200 has been released. In some embodiments, the notification is simultaneously or substantially simultaneously sent to all shift workers 118 that are eligible for any work shifts of the work shift schedule 200. In further embodiments, the processor maintains separate worker lists for each work shift 202 and sends notifications to eligible workers for each work shift 202. In some embodiments, the lists of eligible shift workers 118 are sorted in order of priority or according to other characteristics.

The shift worker device 110 is configured to receive, via a second input device 124, at least one shift selection 204 based on the plurality of unassigned work shifts 202. In some embodiments, the UI generation system 16 provides a user interface to facilitate the shift selection 204. For example, the shift worker 118 may select the shifts by selecting from a menu of available shift selections by selecting fields with the input device, typing characters, selecting regions on a table, selecting visual cues, sound inputs, or any other suitable manner to input a selection. The shift selection 204 is provided to the shift selection system 18. The shift selection system 18 is configured to approve the shift selection 204 if the shift selection meets at least one selection parameter, and reject the shift selection if the shift selection does not meet the at least one selection parameter. For example, the selection parameter may include a maximum number of shifts, a minimum criteria for the shift worker, a supervisor's approval, if another worker has already selected the shift, or any other suitable parameter. The selection parameter may be determined by the shift selection system 18 and/or may be set by an administrator.

For example, in some embodiments, the characteristics associated with the shift workers 118 includes a priority ranking. The conflict resolution system 24 is configured to compare shift selections from a plurality of the shift workers based on the priority ranking and assign the shift to a shift worker with the highest priority ranking. The priority ranking may be based, for example, on at least one of a number of hours worked, an experience level, or a full-time or part-time designation. In some embodiments, the conflict resolution system 24 determines the number of workhours or shifts for each shift workers and compares the workhours or shifts to a target number for each shift worker. The conflict resolution system 24 then sorts the shift workers based on the workhours or shifts. Shift workers that are farther from meeting their target or have less shifts or hours have a higher priority and the shift workers that have met or exceeded the target have a lower priority. In some embodiments, the shift workers are ranked in order of experience level with the most experienced shift workers having the highest priority and the least experienced shift workers having the lowest priority ranking. In some embodiments, the shift workers with a full-time designation are given priority over the shift workers with a part-time designation. In further embodiments, the conflict resolution system 24 utilizes an algorithm that calculates a priority ranking based a plurality of factors. For example, the conflict resolution system 24 sorts the shift workers based on a number of hours worked and the target, with the shift workers requiring the most hours or shifts having the highest priority ranking. The conflict resolution system 24 then further sorts the shift workers such that the shift workers with more experience have a higher priority ranking. Also, the conflict resolution system 24 sorts the shift workers such that the shift workers with a full-time designation will have a higher priority ranking. In some embodiments, the conflict resolution system 24 utilizes a weighted average for the plurality of factors to determine a combined priority ranking. In some embodiments, the administrator can edit or set the priority rankings for the workers. In some embodiments, the administrator selectively releases the schedule information to the shift workers at different times based on the priority ranking such that the workers with a higher priority ranking have earlier access to make schedule selections.

In some embodiments, the unassigned work shifts 202 include weekend shifts and weekday shifts, and the selection parameter includes at least one of a maximum number of weekend shifts, a minimum number of weekend shifts, a maximum number of weekday shifts, or a minimum number of weekday shifts.

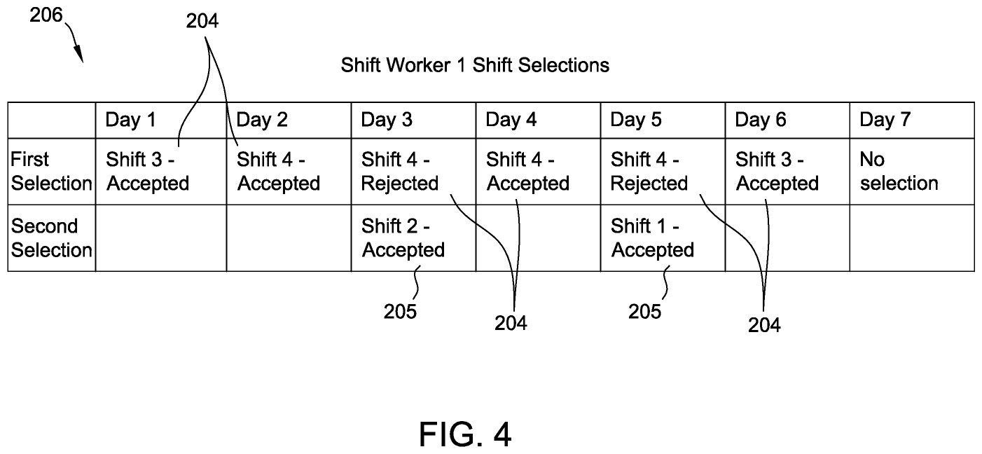

FIG. 4 shows an example of a shift selection table 206 made by a shift worker based on the work shift schedule 200. For example, the shift worker has made shift selections 204 of Shift 3 for Day 1, Shift 4 for Day 2, Shift 4 for Day 3, Shift 4 for Day 4, Shift 4 for Day 5, and Shift 3 for Day 6. The shift worker has not selected a shift for Day 7. The shift selection system rejects the shift selections 204 for Day 3 and Day 5 because the shift selections did not meet at least one selection parameter. For example, the shift selection 204 may be rejected because a shift worker with a higher priority level selected the shift. The other shift worker may have a higher priority level because the shift worker selected the shift earlier and/or the shift worker may have a characteristic such as an experience level, a performance rating, and/or a full-time or part-time designation that provides for a higher priority level. In some embodiments, the shift selections 204 may require supervisor review and the supervisor may reject the shift selections for discretionary reasons. The shift worker may make a second or alternative shift selection 205 for the days where the first shift selection was rejected. For example, the shift worker selected Shift 2 for Day 3 and Shift 1 for Day 5.

The shift worker may submit multiple shift selections 204 simultaneously or may submit the shift selections individually. In addition, in some embodiments, the shift worker may submit alternative selections 205 (e.g., second selections, third selections, etc.) in case a shift selection is rejected. In some embodiments, the system will check the shift selection parameter when the shift worker is inputting shift selections and will not allow the shift worker to submit a shift selection that does not meet the selection parameter. Accordingly, the shift worker is immediately able to input a second shift selection 205 (i.e., an alternative shift selection) in place of the first shift selection 204. In some embodiments, the shift worker will receive a notification that a shift selection is rejected, and the notification will include instructions to submit an alternative shift selection. In some embodiments, all shift selections 204 submitted by a shift worker may be rejected if one of the shift selections does not meet the selection parameter. The shift selections 204 may be rejected automatically and/or sent to an administrator to review and optionally override the rejection.

The calendar system 14 generates and outputs the work shift schedule 102 generated based on the shift selections 204, 205 by the shift workers. For example, the shift selection system 18 receives the shift worker selections 204, 205 inputted using the shift worker device 110, and the conflict resolution system 24 checks for any conflicts (e.g., shift selections that were approved for two or more shift workers for the same shift) and resolves any conflicts (e.g., assigned conflicted shifts to the shift worker with a high priority or notifies the administrator to review and address the conflicts). The shift selection system 18 assigns the shifts to the shift workers for the approved shift selections by associating the shift worker with the shift and recording the assigned shifts 209. The calendar system 14 then generates the work shift schedule 102 including the assigned shifts. The work shift schedule 102 may be presented in a table, a graph, a chart, a data file, or any other suitable format. The administrator may select to release the schedule for the shift workers and/or the system may automatically release the schedule on a selected day.

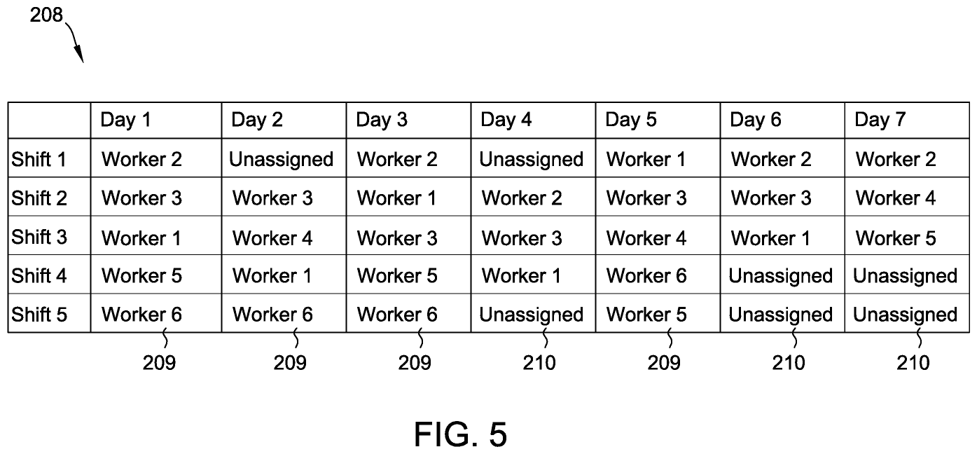

FIG. 5 shows an example work shift schedule 208 including unassigned work shifts 210. The unassigned work shifts 210 are shifts that were not selected by any shift worker who met selection parameters. The shift selection system 18 identifies the unassigned work shifts 210 by comparing the initial list of work shifts provided by the administrator device 104 to the list of approved shift selections. The work shifts from the initial list that are not included in the approved shift selections are the unassigned work shifts 210 in the work shift schedule 208. The communication system 12 may provide a notification to the shift workers and/or the administrator of the unassigned work shifts 210. The shift selection system 18 may identify shift workers that are eligible for the unassigned work shifts 210 and the communication system 12 send the notification to the eligible workers and/or send a list of eligible workers to the administrator. The administrator may contact the eligible workers via the administrator device 104 to request that the shift workers review and select one or more unassigned work shifts 210. In some embodiments, the administrator may contact shift workers not included in the database. In further embodiments, the shift selection system 18 identifies shift workers that did not make shift selections and/or that are assigned shift selections that are less than a predetermined allotment of shifts. The communication system 12 notifies the shift worker and/or the administrator of the under-allocated shift worker.

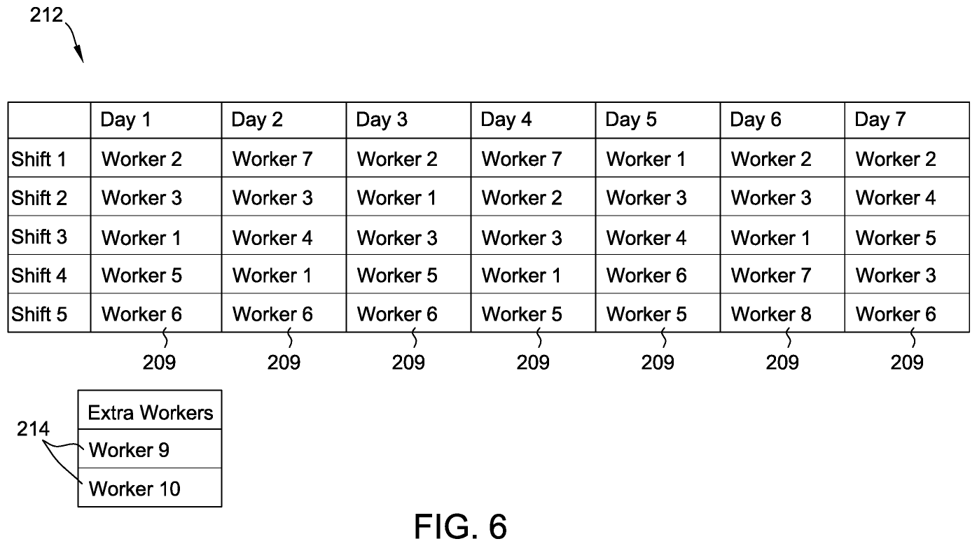

FIG. 6 shows an example work shift schedule 212. The work shift schedule 212 is finalized and includes a plurality of the assigned shifts 209. In this embodiment, the final work shift schedule 212 does not include any unassigned work shifts 210 (shown in FIG. 4). The unassigned work shifts 210 from the work shift schedule 208 have been assigned to shift workers and are now assigned shifts 209 in the work shift schedule 212. For example, the shift workers received notifications of the unassigned work shifts and made additional or alternative shift selections and the shift selections were approved. In addition, the work shift schedule 212 includes new workers that were not assigned shifts in the first work shift schedule 208. The new workers may include shift workers in the database that did not previously make approved shift selections, shift workers that were not previously deemed eligible for the shifts before administrator review (e.g., shift workers that needed approval to sign up for overtime shifts), and/or shift workers that were not previously in the database and that were recruited to fill the unassigned work shifts. In other embodiments, the final work shift schedule 212 may include one or more unassigned work shifts 210. The work shift schedule 212 may include color coding to identify the unassigned work shifts 210, the assigned work shifts 209, and any other items.

The calendar system 14 is configured to output the final work shift schedule 212 when all shifts are assigned, and the final work shift schedule meets all employment compliance criteria. For example, the compliance system 26 may review the work shift schedule 212 to determine if there are any unassigned work shifts 210 and if the work shift schedule 212 meets employment compliance criteria such as overtime restrictions. The employment compliance criteria may include regulations determined by governing authorities and/or internal business policies. The communication system 12 notifies the shift workers and the administrators of the final work shift schedule 212. For example, the communication system 12 may cause an email, text message, or other electronic communication to be sent to the shift workers and the administrator to inform the shift workers and the administrator that the work shift schedule 212 has been completed. In some embodiments, the notification sent to each shift worker may include the shifts that have been assigned to the shift worker. The notification to the administrator and/or the shift workers may include the final work shift schedule 212. In some embodiments, the administrator and/or the shift workers are able to view the final work shift schedule 212 using the administrator device 104 and/or the shift worker device 110. The communication system 12 may determine when the shift worker has received or accepted the final work shift schedule 212. For example, the communication system 12 detect when the shift worker uses the shift worker device 110 to view the shift worker schedule and/or the communication system 12 may receive a signal when the shift worker provides an input related to the shift work schedule using the input device 124.

The administrator is able to view and/or edit the work shift schedule 212 using the administrator device 104. For example, the work shift schedule 212 is displayed on the display device 122 of the administrator device 104 and the administrator can make modifications to the work shift schedule 212 using the input device 124 of the administrator device 104. The shift workers 118 are able to view the work shift schedule 212 using the shift worker device 110. For example, the work shift schedule 212 is displayed on the display device 122 of the shift worker device 110. In some embodiments, the shift workers 118 may request modifications to the work shift schedule 212 (e.g., asking off, calling in sick, or trading shifts) using the shift worker device 110.

The final work shift schedule 212 includes extra workers 214. The extra workers 214 may be shift workers and/or non-shift workers that are not assigned to a specific shift. For example, the extra workers 214 may be administrators that perform administrative and/or managerial duties and facilitate performance of the shift workers but do not actually perform shift work. In other embodiments, the extra workers 214 may be back-up or floater workers that help cover assigned shifts that are not able to be completed by the assigned shift workers. In some embodiments, at least one slot for an extra worker is generated for a designated number of assigned work shifts. In other embodiment, the extra workers 214 are assigned workers that have been called extra, called off, or do not show up.

In some embodiments, the compliance system 26 generates reports and the communication system 12 sends reports to regulatory authorities and/or an administrator to ensure compliance with regulations. For example, the system 100 may track hours performed by shift workers based on the final work shift schedule 212. The shift workers and/or the administrator may be provided a review period after the shifts are completed to confirm the worked hours for each shift worker. The compliance system 26 determines the worked hours for each worker based on the final work shift schedule 212 and generates a report of hours worked and any other compliance or tracking data based on the final work shift schedule 212. In some embodiments, the compliance system 26 automatically generates reports when designated events occur. For example, the compliance system 26 may generate refusal to work reports when an employee has been offered employment but does not accept the work. The compliance system 26 may also generate resignation and termination reports or letters. The reports may be based at least partly on templates stored in the memory. The reports may be sent to the shift workers, the administrator, representatives of the business, and/or third party organizations. In embodiments, the system 100 includes an electronic signature system or other document processing systems.

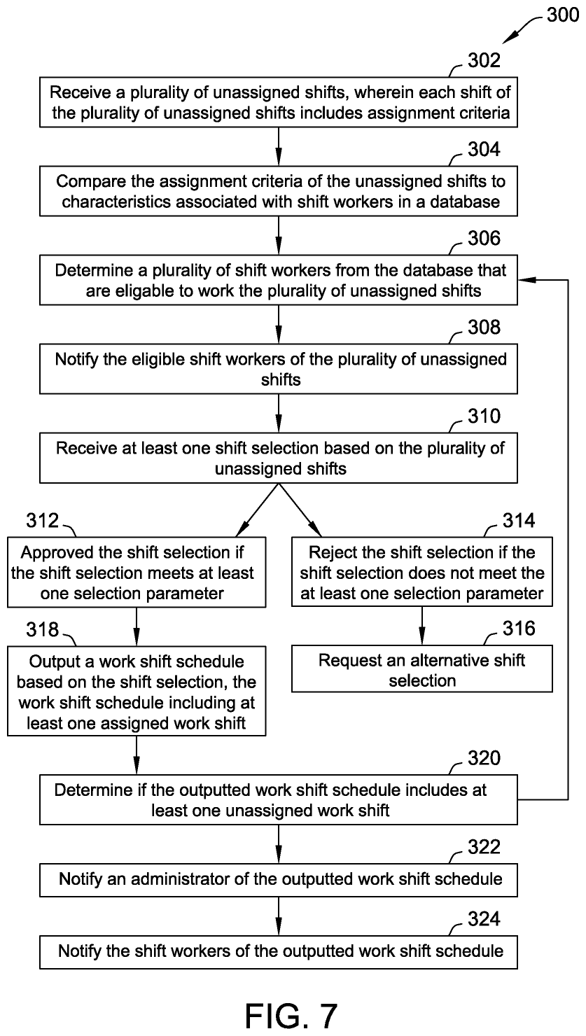

FIG. 7 is a flow diagram of an example method 300 of operating a system for generating work shift schedules, such as the system 100 shown in FIG. 1. Referring to FIGS. 1A-7, the method 300 includes receiving 302 a plurality of unassigned work shifts 202. For example, the unassigned work shifts 202 may be inputted by an administrator using the administrator device 104, the unassigned work shifts 202 may be stored in the memory, and/or the calendar system 14 may generate the unassigned work shifts 202 based on template data, calendars, work orders, and any other data when the administrator inputs a schedule request 201. In the example, each shift of the plurality of unassigned work shifts 202 includes assignment criteria. In some embodiments, the shift selection system 18 retrieves the unassigned work shifts 202 and the associated assignment criteria from the memory and the UI generation system 16 and the communication system 12 provide the unassigned work shifts 202 to the administrator device 104 for the administrator to release.

In the example embodiment, the shift selection system 18 compares 304 the assignment criteria to at least one characteristic associated with the shift workers 118 in the database 106 and determines 306 a plurality of shift workers from the database that are eligible to work the plurality of unassigned work shifts based on the assignment criteria of the unassigned work shifts and the characteristic associated with the shift workers in the database. The method 300 includes notifying 308 the eligible shift workers 118 of the plurality of unassigned work shifts 202. For example, the communication system 12 causes an email, text message, or other electronic communication to be sent to the shift workers 118. In some embodiments, the electronic communication is an alert that is provided to the shift workers 118 via the shift worker device 110. The shift workers 118 are able to view the unassigned work shifts via the shift worker device 110.

The shift selection system 18 receives 310, from the shift worker device 110, at least one shift selection 204 based on the plurality of unassigned work shifts 202. The shift selection system 18 approves 312 the shift selection 204 if the shift selection meets at least one selection parameter. The shift selection system 18 rejects 314 the shift selection 204 if the shift selection does not meet the at least one selection parameter. In some embodiments, the shift selection system 18 requests review from the administrator via the administrator device 104 before the shift selection system rejects or approves the shift selection 204. The shift selection system 18 requests 316 an alternative shift selection 205 if the shift selection does not meet the at least one selection parameter. The shift worker may input the alternative shift selection 205 using the shift worker device 110. In some embodiments, the shift worker 118 receives the request 316 immediately when the shift worker selects or attempts to select a shift. In other embodiments, the shift worker 118 receives the request 316 for an alternative shift selection at a later time after the shift selection system 18 has collected shift selections 204 from other shift workers.

The calendar system 14 outputs 318 the work shift schedule 208, 212 based on the shift selections 204. The shift selection system 18 sorts the assigned shifts 209 and any unassigned work shifts 210 into a database that corresponds to the calendar period for the work shifts entered by the administrator. In the example, the work shift schedule 208, 212 is a table and corresponds to a work week. In some embodiments, the work shift schedule 208, 212 is color coded or includes other visual identifiers to highlight unassigned work shifts 210, assigned work shifts 209, calendar periods, holidays, irregularities in the work shift schedule, conflicts, projected overtime shifts, or any other suitable characteristic.

In the example, the shift selection system 18 determines if the outputted work shift schedule 208, 212 includes at least one of the unassigned work shifts 210. For example, the work shift schedule 208 includes the unassigned work shifts 210. After the calendar system 14 outputs 318 the work shift schedule 208 and the shift selection system 18 determines that the work shift schedule 208 includes unassigned work shifts 210, the method 300 returns to the step of determining 306 a plurality of shift workers from the database that are eligible to work the unassigned work shifts 210. The method 300 progresses through notifying 308 the eligible workers of the unassigned work shifts 210 and receiving 310 the shift selections 204 for the unassigned work shifts 210. The eligible workers may be different than previous lists because the work shift schedule 208 may include some assigned work shifts and less unassigned work shifts 210 than the initial work shift schedule 200. In addition, the assignment criteria associated with the unassigned work shifts 210 may be altered or removed to increase the likelihood of a shift worker selecting the unassigned work shifts 210. In addition, the list of eligible shift workers may be modified based on previous shift selections 204 for the work shift schedule 208. For example, shift workers that have already selected a designated number of shifts may be excluded from the notifications for the remaining unassigned work shifts 210. Accordingly, the system 100 facilitates shift workers selecting and being assigned to shifts in the work shift schedule, even difficult to fill shifts. In some embodiments, the administrator is able to provide incentives for eligible shift workers that select specific work shifts. The incentives may be selected from predetermined options or generated by the administrator. The administrator may select shift workers to receive the incentives. In some embodiments, the shift selection system 18 utilizes computer learning to adapt the assignment criteria associated with unassigned work shifts 210 for future initial work shift schedules 200 to increase the likelihood of a shift worker selecting the unassigned work shifts 210. In addition, the shift selection system 18 may store the initial and alternative shift selections of the shift workers in the memory. Accordingly, the shift selection system 18 is able to identify and generate reports for popular or unpopular shifts, patterns in the shift workers selections, and other statistics for use in future scheduling. In some embodiments, the shift selection system 18 may predict at least some shift selections for the shift workers based on historical data. As a result, the shift selection system 18 facilitates quicker and easier shift selections by the shift workers and resource planning and leveling by the business.

After the shifts have been assigned, the calendar system 14 outputs 318 the final work shift schedule 212. The shift selection system 18 determines 320 that the work shift schedule 212 includes only assigned work shifts 209. In some embodiments, the compliance system 26 compares the outputted work shift schedule 212 to employment compliance criteria. In the example, the communication system 12 notifies 322 an administrator of the outputted work shift schedule 212. In addition, the communication system 12 notifies 324 the shift workers of the outputted work shift schedule 212. For example, the communication system 12 may cause an email, text message, or other electronic communication to be sent to the shift workers and the administrators that the work shift schedule 212 has been completed. In some embodiments, the electronic communication is an alert that is provided to the shift workers 118 or the administrator via the shift worker device 110 or the administrator device 104. In some embodiments, the notification includes the work shift schedule 212.

In embodiments, the compliance system 26 updates the work shift schedule 212 and/or reports related to the work shift schedule based on performance of the shift workers for the assigned shifts. For example, the compliance system 26 may track and record hours and/or shifts actually performed by the shift workers in the memory. The compliance system 26 adjusts hours worked and remaining hours if a shift worker does not work a shift because, for example, the shift worker is called extra, called off, or does not show up.

The compliance system 26 may cause the communication system 12 to send notifications or highlight portions of the work shift schedule 212 if there is a discrepancy such as an unassigned worker logging hours and/or a shift assignment that may not meet compliance requirements. Accordingly, the compliance system 26 may update characteristics associated with the shift workers based on the shifts worked. The compliance system 26 may automatically send notifications to the shift workers and/or the administrators if shift workers become eligible for unassigned work shifts due to updates.

The compliance system 26 compares the hours of the shift workers to employment regulations and/or internal business policies stored in the memory. In some embodiments, the compliance system 26 determines the hours of the shift workers and compares the hours to the compliance requirements before the work shift schedule 212 can be finalized.

The work shift schedule 212 may include characteristics associated with the shift workers assigned to the shifts. For example, the work shift schedule 212 may include a visual name and/or an image associated with each of the shift workers.

In embodiments, the system 100 includes a payroll system and/or other human resources system that provides services for employees. For example, in some embodiments, the system 100 includes a payroll system that generates payments for the shift workers based on the hours or shifts recorded by the compliance system 26 from the work shift schedule 212. In embodiments, the system correlates the work shifts, the hours worked, and/or the payments with codes associated with the human resources systems. In addition, in embodiments, the system 100 facilitates shift workers clocking in or out using the shift worker device 110. In some embodiments, the system 100 includes a location tracking module and monitors locations of the shift workers. For example, the shift worker is able to clock in when the shift worker is at a designated location. For example, the system 100 includes a hub located at a physical location and/or a defined geofence. The hub registers when a shift worker and/or an enabled device associated with the shift worker is within a specified distance of the hub based on the location information associated with the worker. In other embodiments, the location information associated with the worker is compared to a geofence location. The location tracking and the timekeeping system may be at least partly incorporated into the shift worker device 110 and be available on, for example, the shift workers smartphone or other mobile computing device. The shift workers within the designated location or within a distance of the hub are able to access the shift worker device 110 to clock-in, clock-out, or perform other location locked actions. In some embodiments, the shift workers are restricted based on IP address used by the workers device, e.g., the shift worker can only clock-in when using a specified IP address.

The communication system 12 may include modules or systems on any computing device to facilitate communication with the system 100. For example, in some embodiments, the communication system 12 includes a messaging system on the administrator device 104 and the shift worker device 110 which allows the users to send and/or receive messages or notifications. The messages may include images, audio, and/or videos. For example, the communication system 12 may provide videos or images captured during performance of the shift workers to ensure compliance with requirements and encourage learning of proper behaviors. The messaging systems facilitates the users directly messaging other users or sending mass messages to groups of users. The users may require permission (e.g., administrator approval) to utilize features of the messaging platform such as mass messaging. In embodiments, the communication system 12 facilitates communication between the people in real time. An administrator may select the access of individual workers to view and/or participate in the messaging platform.

FIG. 8 is a block diagram illustrating physical components (e.g., hardware) of a computing device 400 with which aspects of the disclosure may be practiced. The computing device 400 may be integrated or otherwise associated with any of the various systems described above with respect to FIGS. 1A-1E. For example, the computing device 400 may be integrated or otherwise associated with the scheduling system 10, the administrator device 104, and/or the shift worker devices 110.

In a basic configuration, the computing device 400 may include at least one processing unit 410 and a system memory 420. Depending on the configuration and type of computing device, the system memory 420 may comprise, but is not limited to, volatile storage (e.g., random access memory), non-volatile storage (e.g., read-only memory), flash memory, or any combination of such memories. The system memory 420 may include an operating system 430 and one or more program modules 440 or components suitable for performing the various operations described above. The operating system 430 may be suitable for controlling the operation of the computing device 400. The system memory 420 may include a scheduling system 450 such as scheduling system 10 and/or one or more subsystems of the scheduling system 10.

The computing device 400 may have additional features or functionality. For example, the computing device 400 may also include additional data storage devices (removable and/or non-removable) such as, for example, magnetic disks, optical disks, or tape. Such additional storage is illustrated in FIG. 8 by a removable storage device 460 and a non-removable storage device 470.

As stated above, a number of program modules 440 and data files may be stored in the system memory 420. While executing on the processing unit 410, the program modules 440 may perform the various processes including, but not limited to, the aspects, as described herein.

Furthermore, examples of the disclosure may be practiced in an electrical circuit comprising discrete electronic elements, packaged or integrated electronic chips containing logic gates, a circuit utilizing a microprocessor, or on a single chip containing electronic elements or microprocessors. For example, examples of the disclosure may be practiced via a system-on-a-chip (SOC) where each or many of the components illustrated in FIG. 8 may be integrated onto a single integrated circuit. Such an SOC device may include one or more processing units, graphics units, communications units, system virtualization units and various application functionality all of which are integrated (or “burned”) onto the chip substrate as a single integrated circuit.

When operating via an SOC, the functionality, described herein, with respect to the capability of client to switch protocols may be operated via application-specific logic integrated with other components of the computing device 400 on the single integrated circuit (chip). Examples of the disclosure may also be practiced using other technologies capable of performing logical operations such as, for example, “AND”, “OR”, and “NOT”, including but not limited to mechanical, optical, fluidic, and quantum technologies. In addition, examples of the disclosure may be practiced within a general-purpose computer or in any other circuits or systems.

The computing device 400 may also have one or more input/output device(s) 485. These include, but are not limited to, a keyboard, a trackpad, a mouse, a pen, a sound or voice input device, a touch, force and/or swipe input device, a display, speakers, a printer, etc. The aforementioned devices are examples and others may be used. The computing device 400 may include one or more communication systems 480 that allow or otherwise enable the computing device 400 to communicate with remote computing devices 495. Examples of suitable communication connections include, but are not limited to, radio frequency (RF) transmitter, receiver, and/or transceiver circuitry; universal serial bus (USB), parallel, and/or serial ports.

The computing device may include one or more sensors 490. The sensors may include location sensors, accelerometers, position sensors, capacitive touch sensors, the like.

The term computer-readable media as used herein may include computer storage media. Computer storage media may include volatile and nonvolatile, removable and non-removable media implemented in any method or technology for storage of information, such as computer readable instructions, data structures, or program modules.

The system memory 420, the removable storage device 460, and the non-removable storage device 470 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 400. Any such computer storage media may be part of the computing device 400. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

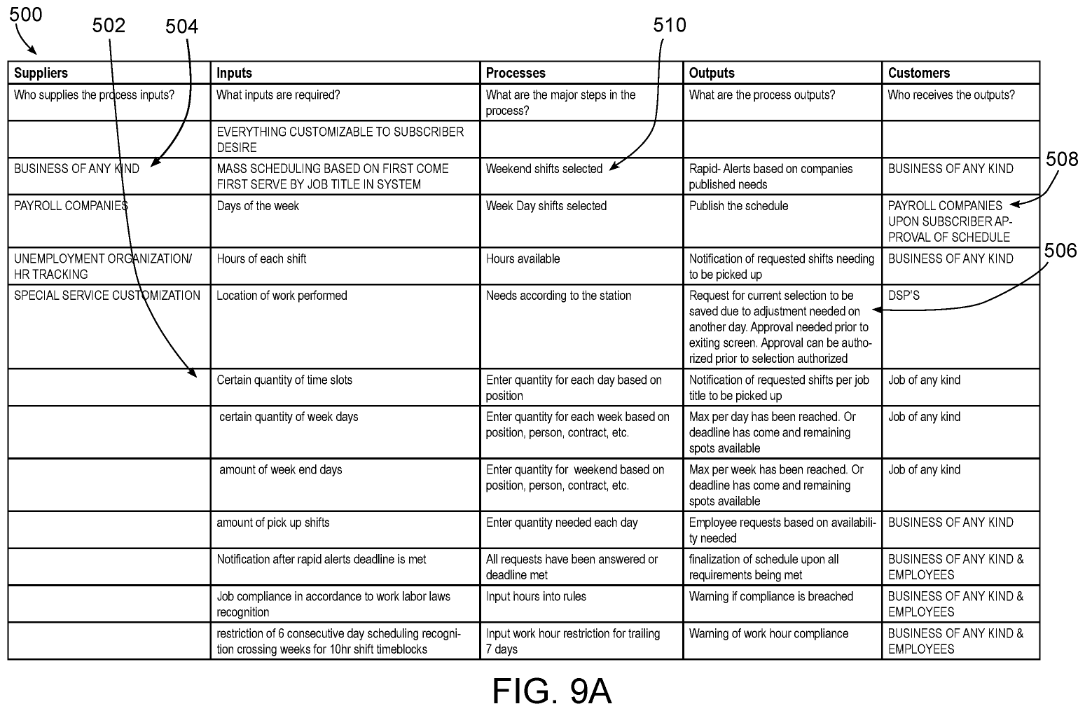

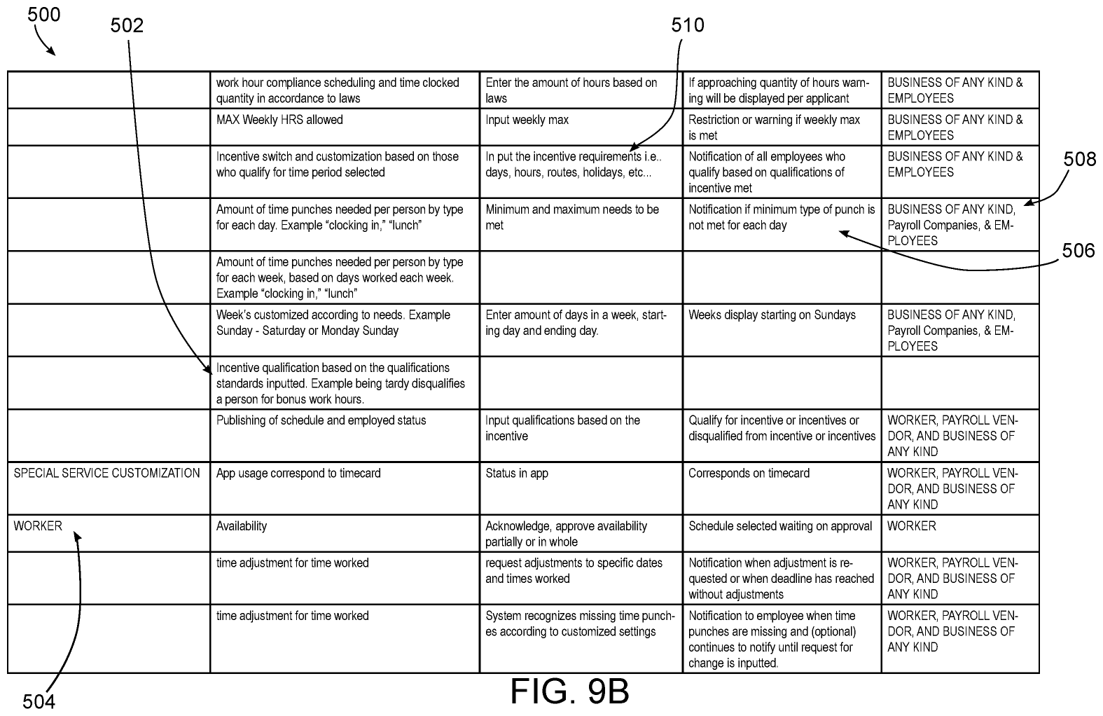

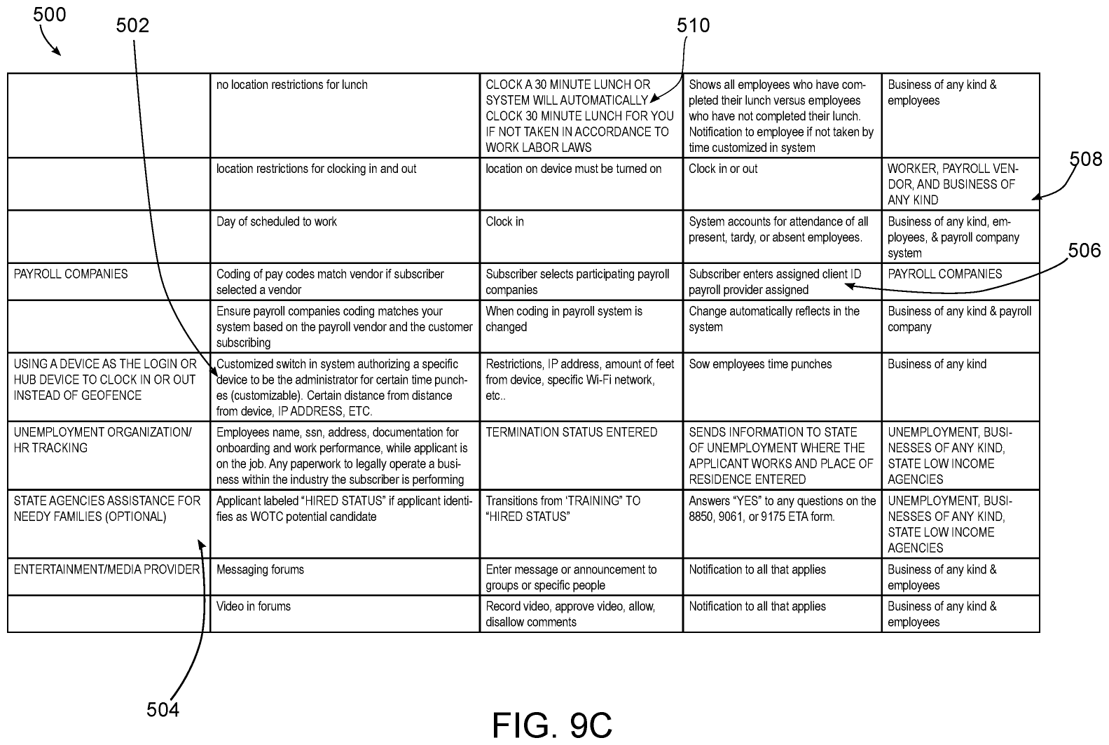

FIGS. 9A-9C illustrate an example embodiment of a system 500 for generating work shift schedules. The system 500 receives inputs 502 from input entities 504 and provides outputs 506 to the customers 508. Some parties are both input entities 504 and customers 508. Inputs 502 include, for example and without limitation, business scheduling requirements, calendar days, shift hours, locations, quantity of time slots, amount of weekend days, amount of pick-up shifts, notifications requirements after rapid alerts, job compliance requirements, maximum weekly hours, incentive settings for qualified workers, maximum and minimum amount of time punches per shift, maximum and minimum amount of time punches per week, calendar customizations, incentive qualifications or standards, requirements for schedule publication and employment status, timecard format and usage with mobile applications, worker availability, requests for time worked adjustments, automated adjustments of time worked based on error detection settings, lunch or break data, pay code data for selected vendors, comparison of vendor pay code data and the system pay code data, location data, employee characteristics, employee status for government programs, messaging data, and multimedia data.

The system 500 receives the inputs 502 and performs one or more processes 510 based on the inputs 502 and generates the outputs 506. For example, the system 500 receives the business scheduling requirements from the business entities, identifies weekend shifts selected, and generates rapid alerts based on the company's business scheduling requirements. The rapid alerts are sent to the businesses. The system 500 identifies weekday shifts selections based on the days of the week received from the payroll companies and outputs a published schedule to the payroll companies. The system 500 receives the hours of each shift from the unemployment organization, determines hours available, and outputs a notification to the business entities of the requested shifts that need to be picked up.

In some embodiments, the system 500 is customized to receive and generate special information for a customer or vendor. The system 500 may receive or generate any suitable parameters and may be customized based on customer preferences or needs. In the example, the system 500 receives the location of work to be performed, determines needs based on the location, and outputs a parameter to the direct support professional (DSP) based on the location. For example, the system may generate a request for the current selection to be saved due to adjustment needed on another day because the system 500 may not be able to receive a selection based on the current location. The system 500 may require approval prior to exiting a screen. Approval can be authorized prior to selection of an option.

In the example, the system 500 receives the quantity of weekdays and weekend days and determines hours or shifts for each shift worker for each week day and each weekend. The system 500 sends a notification when the maximum per day hours or the maximum per week hours have been reached or a deadline has occurred, and remaining spots are available. The system 500 receives the amount of pick-up shifts, identifies the quantity of shifts needed each day, and outputs employee requests based on availability needed. The system receives a notification after rapid alerts deadlines are met, determines if all requests have been answered or the deadline occurred, and outputs a finalized schedule to business entities and workers based on the requirements.

The system 500 receives job compliance data and rules, compares hours to the data and outputs warnings if compliance rules are breached or the projected schedule is approaching breach to the business entities and the workers. For example, the system receives an input restricting work to no more than 6 consecutive days within the same week or across multiple weeks and determines if selected shifts would violate the restriction. The system outputs a warning to businesses and workers if the work restriction is breached. The system determines a limit of number of hours for work hour compliance based on applicable regulations and outputs a warning if the quantity of hours approaches the limit. The system compares selected or assigned hours to maximum weekly hours and restricts the selected hours or outputs a notification when the maximum weekly hours is met.

In addition, the system determines if a worker is qualified for and meets incentive requirements based on the incentive parameters and outputs a notification to the business and workers if the respective workers have earned incentives. The system determines if the minimum and maximum number of time punches are met and outputs a notification to the businesses, payroll companies, and the worker if the minimum number of time punches is not met for a shift. The system determines the amount of days in the week, the starting day, and the ending day for a calendar period based on the inputted calendar data and outputs a calendar week to be displayed for the businesses, payroll companies, and workers. The system determines worker qualifications for incentives and publishes the qualification status (e.g., qualified for incentives or disqualified for incentives) onto the schedule for the worker, the payroll company, and the businesses.

In some embodiments, the system 500 includes a special service customization that enables use of the system on a mobile computing device. For example, the system 500 receives application usage data that relates to a timecard and determines a status of the timecard in the application based on the usage data. The system correlates the timecard to the application usage in the mobile device and provides the status and correlation information to the worker, payroll companies, and the businesses.

The system 500 receives availability data, time adjustment data, location restriction data, and days of scheduled work from the worker. The system acknowledges and/or approves the availability data in part or entirely. In some embodiments, the system 500 schedules shifts for the available time pending approval. The system receives the worker's request for time adjustments for specific times and dates and makes the adjustment if requests are true. The system also recognizes missing time punches according to automated adjustments and generates notifications to workers when time punches are missing and, optionally, continually notifies the workers until a request for adjustment is entered. The system outputs notifications of requests, entered adjustments, and adjustment deadlines to the worker, the payroll companies, and the businesses. The system determines if the worker has clocked out for any mandatory breaks or lunch periods and outputs a report of the workers who have completed lunch or breaks to the workers and the businesses. The system outputs notifications to the workers if the workers have not completed a lunch or break by a designated time. The system receives the location information from the worker, for example from a computing device associated with the worker, and determines if the location information is accurate and current and enables the worker to clock-in or clock-out if the location information meets restrictions. The system provides notifications of the clock-in or clock-out and, optionally, the associated location information to the worker, the payroll company, and the businesses. The system determines a scheduled day of work, associates the clock-in with the scheduled day, and provides a report of attendance including present, tardy, and absent workers. The report is outputted to the businesses, the workers, and the payroll companies.

The system 500 receives pay code information from the payroll companies. For example, the system receives pay codes from a plurality of payroll companies, and selects the appropriate pay codes that are associated with a payroll company selected by the customer. The system provides the pay codes and the subscriber enters an assigned client identification code associated with the subscriber, which the system outputs to the payroll companies. The system compares the pay codes provided by the payroll company and the pay codes entered by the user and identifies any changes. The system automatically updates the stored pay codes based on changes of the payroll companies pay codes. The pay codes are outputted to the businesses and the payroll companies. Accordingly, the system 500 reduces time spent comparing and converting time codes and simplifies the accounting process.

In some embodiments, a computing device associated with the worker is used for time entries and the time entries are restricted based on location. For example, the system 500 receives a location setting which authorizes a device to act as an administrator and authorize specified time entries. For example, the time entries may be authorized based on a distance from the device or an IP address. The system restricts the received time entries (e.g., accepts or rejects) based on the restriction setting, the IP address, the distance from the administrator device, a specific wireless network, or any other suitable parameter. The system outputs the authorized time entries to the businesses.

The system 500 receives characteristic information associated with the workers from an unemployment tracking organization. For example, the characteristic information includes a worker's name, a social security number, an address, onboarding documentation, and work performance records. The system also receives documentation necessary to operate a business within the respective industry. The system collects the information and determines when a termination status is entered for the worker. The system sends the information to the state unemployment organization where the worker is located and to the residence of the worker.

Optionally, the system 500 receives worker information from government subsidy programs and associates the information with workers. For example, the system may identify workers that may be eligible for a work opportunity tax credit (WOTC) and generates a status for the workers (e.g., transitions the worker from “training” to a “hired” status). The system outputs appropriate entries in tax and record keeping forms for the worker based on the government subsidy programs. For example, for the WOTC, the system answers “Yes” to applicable questions on tax forms 8850, 9061, or 9175. The system sends information to the unemployment office, the businesses, and government agencies.

The system 500 receives messaging data from entertainment/media providers (e.g., applications on a mobile computing device) and enters the messages into forums for groups or specific people or sends announcements to people. In addition, the system receives video or other multimedia from the providers and records, reviews, and approves/disapproves the video to be posted in the forum. The system enables or disables comments for the video. The system 500 sends notifications to the workers and the businesses relating to the multimedia postings.

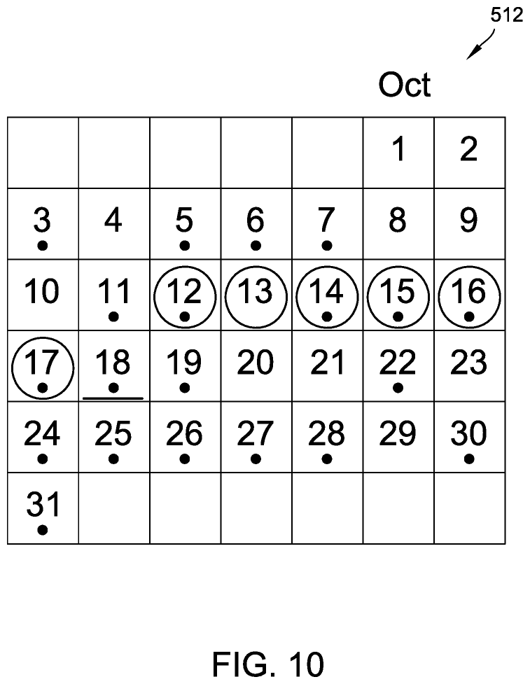

FIG. 10 illustrates an example page of a worker interface 512 of the system 500. The worker interface 512 includes a calendar period and highlights or otherwise indicates days that are selected by the worker as available. The worker interface 512 may also indicate when the worker is unavailable due to worker requests and/or consecutive shift or time off requirements.

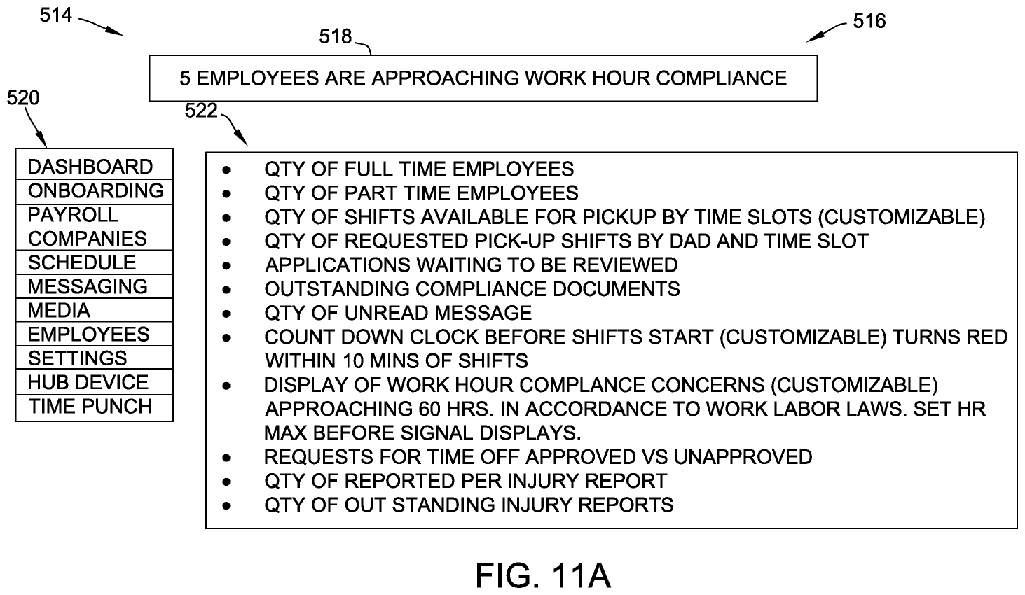

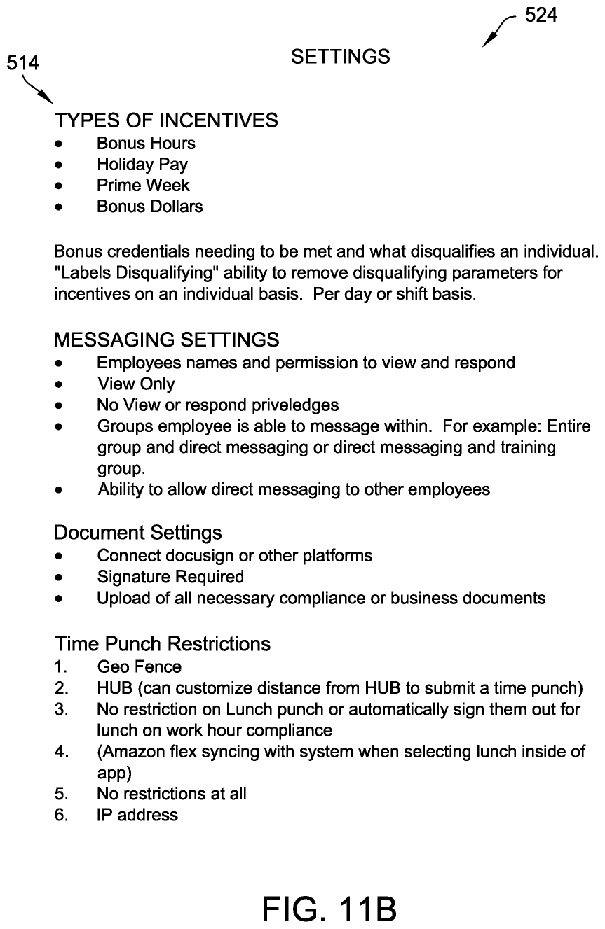

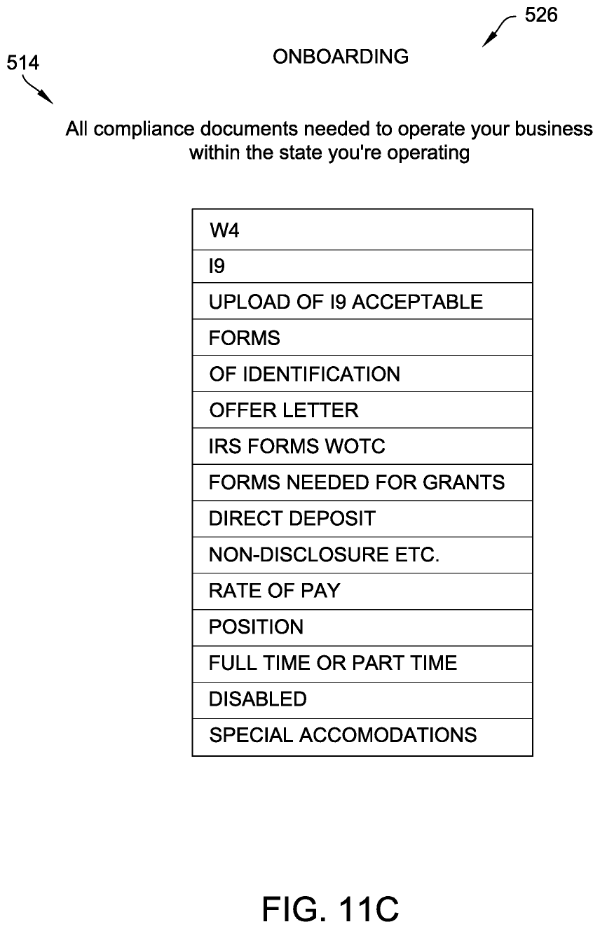

FIGS. 11A-11C illustrate a user interface 514 for use with the system 500. The user interface 514 includes a dashboard 516 with notifications 518, a menu 520, and status or work information 522. In the illustrated embodiment, the notifications 518 include an alert that “5 employees are approaching work hour compliance.” The notification 518 may be customized by the user to display additional or different information. The menu 520 facilitates the user navigating to different pages. For example, the menu 520 has selectable buttons including “DASHBOARD”, “ONBOARDING”, “PAYROLL COMPANIES”, “SCHEDULE”, “MESSAGING”, “MEDIA”, “EMPLOYEES”, “SETTINGS”, “HUB DEVICE”, and “TIME PUNCH”. In some embodiments, the buttons include drop down menus with additional options.

The status or work information 522 includes data or links to data relating to, for example and without limitation, quantity of full-time employees, quantity of part-time employees, quantity of shifts available for pickup sorted by time slots or other parameters, quantity of requested pick-up shifts by day and time slot, applications waiting to be reviewed, outstanding compliance documents, quantity of unread messages, count down clock before shifts start, work hour compliance concerns, status of time off requests, quantity of reported per injury report, and/or quantity of outstanding injury reports. Some of the information 522 may be highlighted or include visual indicators. For example, the countdown clock may turn red or another color within 10 minutes of a shift beginning. The interface 514 may provide notifications based on or related to the information 522. For example, the work hour compliance information may be provided as a notification when the worker is approaching 60 hours or another limit in accordance with applicable labor laws. The dashboard 516 of the user interface 514 is customizable. For example, the user may select the information 522 that is visible on the dashboard and edit the menu 520.

FIG. 11B illustrates an example page 524 of the user interface 514. The user may navigate to the page 524 using the menu 520 of the dashboard 516. In the example, the page 524 is titled “Settings” and includes settings that may be selected by the user to customize the system. For example, the user may select a type of incentive such as bonus hours, holiday pay, prime week, and bonus dollars. The selected incentive is then applied for qualified workers in the scheduling system. The user can select bonus credentials that need to be met and/or criteria that can disqualify an individual. The user can remove disqualifying parameters for incentives on an individual basis per day or shift. The settings page 524 also includes selectable parameters for messaging. The messaging options include employee names and selectable permissions for the employee to view and respond to messages, to view messages only, no access to view or respond, designated addressee groups for each worker to send to, and ability to send direct messages. The settings page 524 includes document settings such as connecting digital signature platforms, requiring signature on specified documents, and uploading necessary compliance or business documents. The settings page 524 also includes options for time entry restrictions such as a geographical fence, a location hub, unrestricted lunch entry or automatic entry for lunch or a break based on a work compliance, a special program synchronization when selecting lunch on a special program application, unrestricted time entries, and/or specific IP address required to submit a time entry.

FIG. 11C illustrates another example page 526 of the user interface 514. The user may navigate to the page 526 using the menu 520 of the dashboard 516. In the example, the page 526 is an “Onboarding” page. The onboarding page 526 includes compliance documents required to hire or onboard a new employee or worker for a business in accordance with employment regulations. For example, the onboarding page 526 includes documents or access to documents such as “W4”, “I9”, “Upload of an acceptable I9 form of identification”, “Offer letter”, “IRS Forms WOTC”, “Forms needed for grants”, “Direct deposit”, “Non-disclosure agreement”, “Rate of pay”, “Position”, “Full-time or part-time”, “Disability”, and “Special Accommodations”. The forms may be uploaded by a user, retrieved from the memory, and/or accessed from a remote database, e.g., a database of forms by a regulatory agency. The forms may be at least partially filled in using the user interface 514 and/or downloaded for filling out. In some embodiments, the forms are at least partly prefilled by the system based on stored information. The forms may be business generated forms, templates, tax documents, occupational safety and health administration forms, individual identification forms, and/or any other documents.

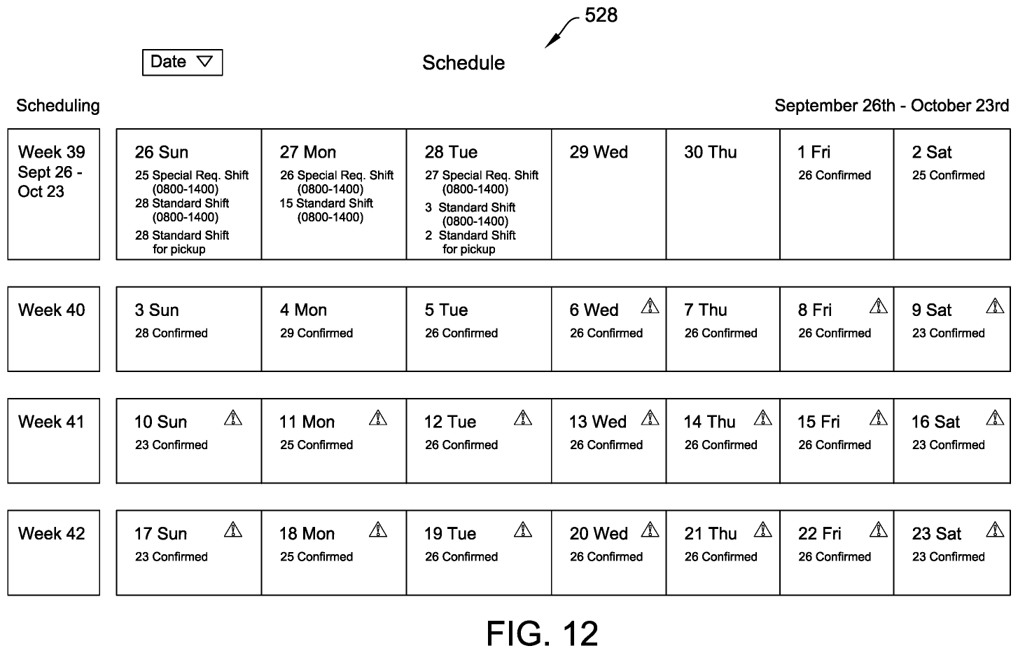

FIG. 12 illustrates an example work request interface 528. An administrator inputs information into the request interface 528 to generate a schedule request. The request interface displays calendar data and a desired number of shifts for at least one category based on the administrator inputs. For example, the request interface displays a number of special requirements shifts and a number of standard shifts for September 26-September 28. In the example, each shift includes a category, a time frame, and a date. The system receives the number of requested shifts from the administrator and/or automatically generates the shifts based on historical data, the calendar information, and the administrator input. In addition, the system determines and displays a number of pickup shifts for each category. For example, the system may receive the requested number of shifts and subtract any assigned shifts to determine the number of shifts for pickup. The work request interface 528 includes a number of shifts that have been confirmed or assigned for dates in the future. The administrator may review and edit or update the confirmed shifts and the number of requested shifts.

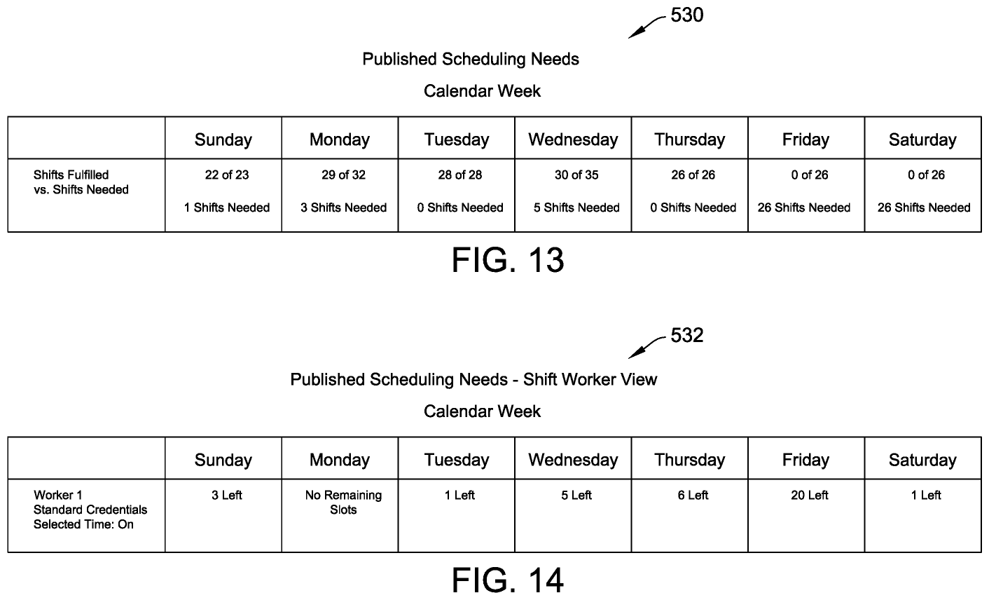

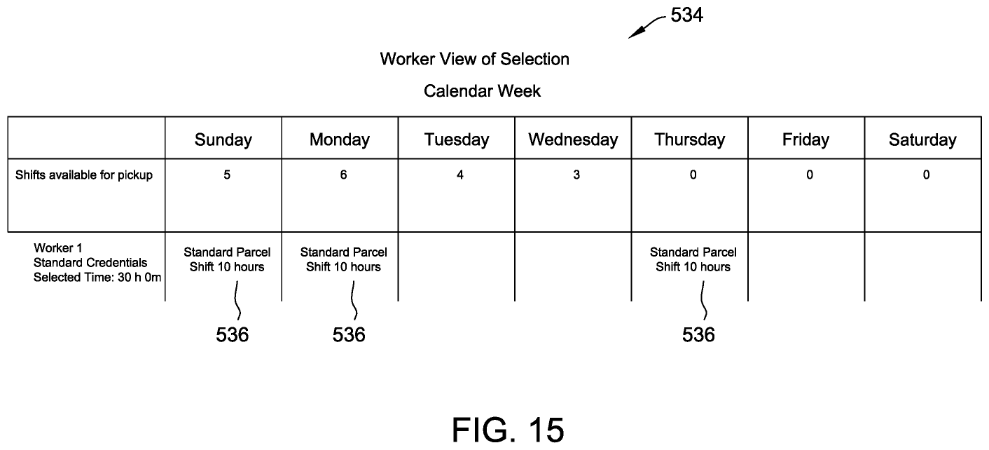

FIG. 13 illustrates an overall published scheduling request 530. The request 530 includes a number of shifts assigned or fulfilled compared to a number of shifts needed. The request 530 includes highlighting, e.g., a different text color, for days that do not have all of the needed shifts filled. The workers each receive an individual schedule request such as the request 532 shown in FIG. 14. The request 532 includes the number of shifts available for each day of the week. The workers select shifts using the selection interface 534 shown in FIG. 15. The user makes selections 536 of shifts based on the shifts available for pickup. The system approves or disapproves the selections.

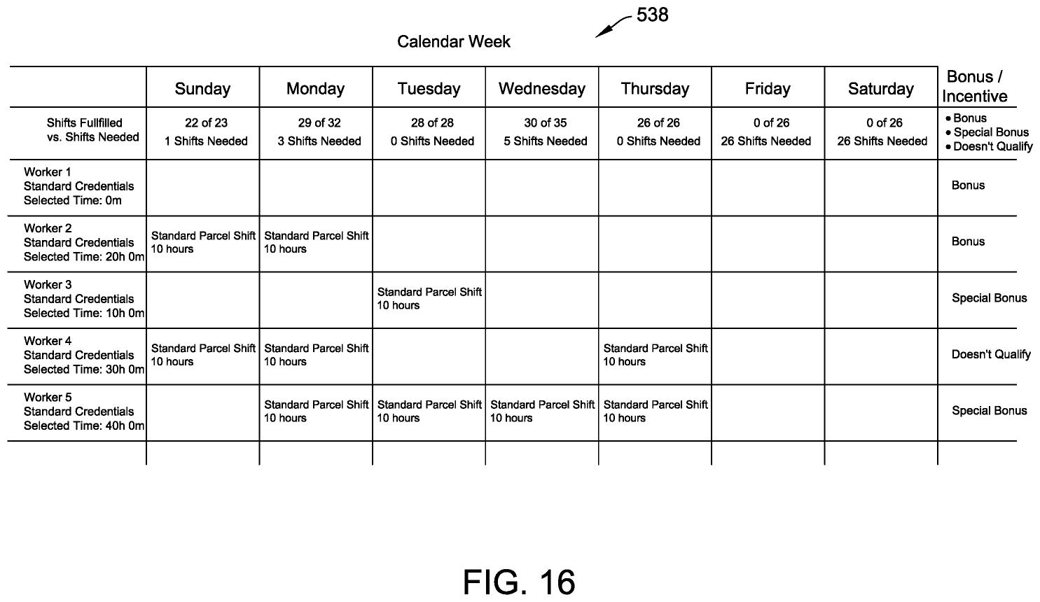

FIG. 16 illustrates an example shift worker schedule 538 generated based on the scheduling request 530 and the selections 536 of the shift workers. The shift worker schedule may be provided to an administrator, the shift workers, and third parties. The shift worker schedule includes a comparison of the fulfilled and needed shifts and the selection of each shift worker. In addition, the shift worker schedule includes bonus or incentive information such as if each individual worker is qualified for specific bonuses.

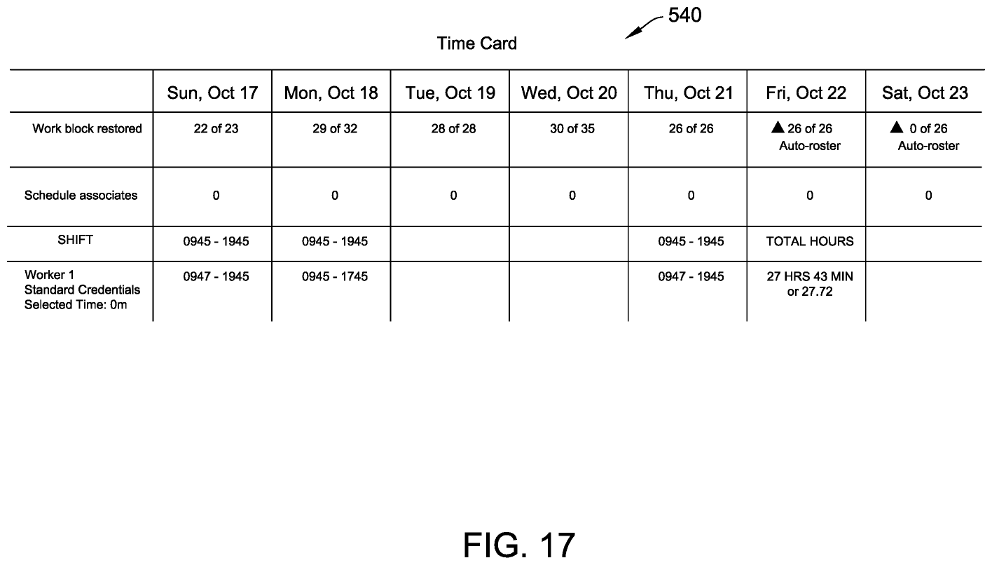

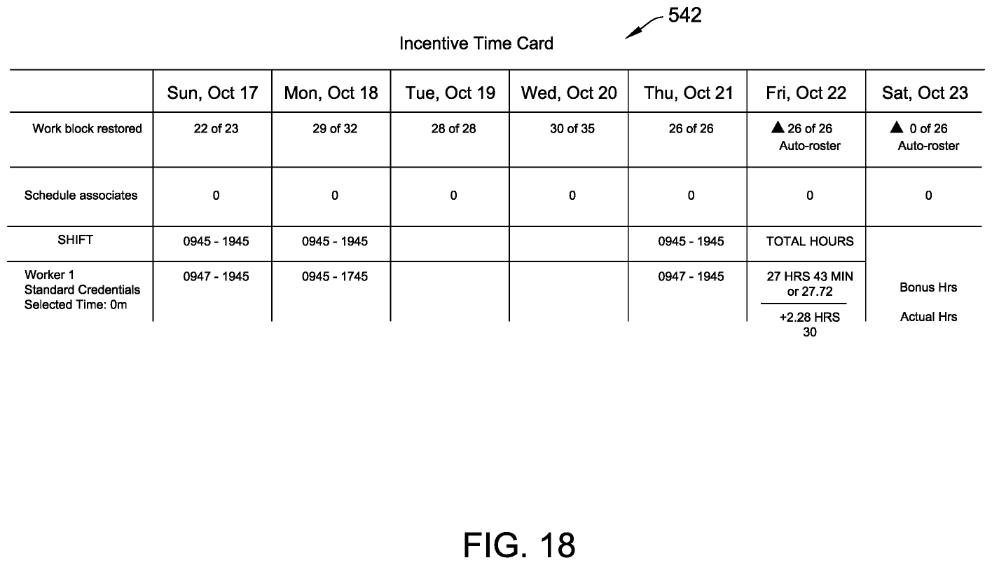

FIG. 17 illustrates an example time card 540 for a shift worker. The time card 540 includes assigned shifts for the worker and the actual hours worked for the shift worker based on the assigned shifts. FIG. 18 illustrates an example incentive time card 542. In the example, the shift worker received an additional credit for 2.28 hours (e.g., bonus hours) because the shift worker qualified for an incentive. The shift worker may receive additional pay and/or other credit for the additional hours.

Accordingly, embodiments of the present disclosure include a system that generates work shift schedules based on shift worker inputs and administrator requirements. The system simplifies the scheduling process and outputs work shift schedules that comply with regulatory requirements and internal business objectives. The work shift schedules include assigned tasks that have been directly selected by the shift workers and increase the likelihood that the shift workers will be satisfied with the work shift schedules. In addition, the work shift schedules take less time to generate and, therefore, cost less for a business than work shift schedules that are manually generated. Moreover, the system decreases human errors associated with generating work shift schedules.

Embodiments provide automatic notifications and reporting when unassigned tasks are available, a work shift schedule is generated, changes are made to the work shift schedules, and/or tasks related to the work shift schedule are performed. Accordingly, the system facilitates shift workers quickly selecting desired work shifts and administrators promptly and timely reviewing selections and/or the outputted work shift schedules. Also, embodiments of the system facilitate recognizing work shifts that are likely to cause conflicts and/or work shifts that may be difficult to assign. The system ensures compliance with employment reporting requirements because embodiments of the system are configured to automatically generate reports for regulatory authorities and/or the administrators of the business.

When introducing elements of the present disclosure or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above constructions without departing from the scope of the disclosure, it is intended that all matter contained in the above description and shown in the accompanying drawings shall be interpreted as illustrative and not in a limiting sense. Although specific features of various embodiments of the disclosure may be shown in some drawings and not in others, this is for convenience only. In accordance with the principles of the disclosure, any feature of a drawing may be referenced and/or claimed in combination with any feature of any other drawing.

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims. Regardless of whether shown and described in combination or separately, the various features (both structural and methodological) are intended to be selectively included or omitted to produce an embodiment with a particular set of features. In addition, each of the operations described above may be executed in any order. For example, one operation may be performed before another operation. Additionally, one or more of the disclosed operations may be performed simultaneously or substantially simultaneously.

What is claimed is:

1. A system for generating work shift schedules, said system comprising:
a processor, and
a memory communicatively coupled to the processor and storing instructions that, when executed by the processor, perform operations comprising:
receiving a schedule request;
determining a plurality of unassigned work shifts based on the schedule request, wherein each shift of the plurality of unassigned work shifts includes assignment criteria;
determining a plurality of shift workers from a database of shift workers that are eligible to work the plurality of unassigned work shifts based on the assignment criteria of the unassigned work shifts and a characteristic associated with the shift workers in the database;
providing a notification relating to the plurality of unassigned work shifts to the eligible shift workers;
providing a menu of available shift selections for each eligible shift worker;
receiving at least one shift selection from the eligible shift workers;
approving the shift selection if the shift selection meets at least one selection parameter;
outputting a work shift schedule based on the shift selection, wherein the work shift schedule includes at least one assigned work shift;
providing a notification of the outputted work shift schedule to an administrator; and
providing a notification of the outputted work shift schedule to the shift workers.

2. A system in accordance with claim 1, further comprising instructions that cause the processor to determine if the outputted work shift schedule includes at least one unassigned work shift and notify the shift workers of the unassigned work shift.

3. A system in accordance with claim 1, further comprising instructions that cause the processor to request an alternative shift selection if the shift selection does not meet the at least one selection parameter.

4. A system in accordance with claim 3, further comprising instructions that cause the processor to:
receive an alternative shift selection;
approve the alternative shift selection if the alternative shift selection meets the at least one selection parameter; and
reject the alternative shift selection if the shift selection does not meet the at least one selection parameter.

5. A system in accordance with claim 1, wherein the characteristic associated with the workers include at least one of a full-time or part-time designation, an experience level, a performance rating, a limit on a number of shifts, a priority ranking, or a restriction on which shifts can be selected by the shift worker.

6. A system in accordance with claim 5, wherein the assignment criteria includes at least one of a full-time or part-time designation requirement, an experience level requirement, or a performance rating requirement.

7. A system in accordance with claim 1, wherein the characteristic associated with the shift workers is a priority ranking, and wherein the processor is configured to compare shift selections from a plurality of the shift workers based on the priority ranking and assign the shift to a shift worker with the highest priority ranking.

8. A system in accordance with claim 7, wherein the priority ranking is based on at least one of a number of hours worked, an experience level, or a full-time or part-time designation.

9. A system in accordance with claim 1, wherein the plurality of unassigned work shifts include weekend shifts and weekday shifts, and wherein the selection parameter includes at least one of a maximum number of weekend shifts, a minimum number of weekend shifts, a maximum number of weekday shifts, or a minimum number of weekday shifts.

10. A system in accordance with claim 1, further comprising instructions that cause the processor to output a final work shift schedule when all shifts are assigned, and the final work shift schedule meets all employment compliance criteria.

11. A system in accordance with claim 10, further comprising instructions that cause the processor to determine worked hours for the shift workers based on the final work shift schedule and generate a report related to the worked hours.

12. A method for generating work shift schedules, said method comprising:
receiving a plurality of unassigned work shifts, wherein each shift of the plurality of unassigned work shifts includes assignment criteria;
comparing the assignment criteria to at least one characteristic associated with shift workers in a database;
determining a plurality of shift workers from the database that are eligible to work the plurality of unassigned work shifts based on the assignment criteria of the unassigned work shifts and the characteristic associated with the shift workers in the database;
providing a notification relating to the plurality of unassigned work shifts to the eligible shift workers;
providing a menu of available shift selections for each eligible shift worker;
receiving at least one shift selection from the eligible shift workers;
approving the shift selection if the shift selection meets at least one selection parameter;
outputting a work shift schedule based on the shift selection, wherein the work shift schedule includes at least one assigned work shift;
providing a notification of the outputted work shift schedule to an administrator; and
providing a notification of the outputted work shift schedule to the shift workers.

13. A method in accordance with claim 12, further comprising:
determining if the outputted work shift schedule includes at least one unassigned work shift; and
notifying the shift workers of the unassigned work shift.

14. A method in accordance with claim 12, further comprising requesting an alternative shift selection if the shift selection does not meet the at least one selection parameter.

15. A method in accordance with claim 14, further comprising:
receiving an alternative shift selection;
approving the alternative shift selection if the alternative shift selection meets the at least one selection parameter; and
rejecting the alternative shift selection if the alternative shift selection does not meet the at least one selection parameter.

16. A method in accordance with claim 12, further comprising outputting a final work shift schedule when all shifts are assigned and the final work shift schedule meets all employment compliance criteria.

17. A method in accordance with claim 16, further comprising determining worked hours for the shift workers based on the final work shift schedule and generating a report relating to the worked hours.

18. A method in accordance with claim 12 further comprising rejecting the shift selection if the shift selection does not meet the at least one selection parameter.

19. A system comprising:
a processor; and
a memory communicatively coupled to the processor and storing instructions that, when executed by the processor, perform operations, comprising:
sending a plurality of unassigned work shifts to shift workers, wherein each shift of the plurality of unassigned work shifts includes assignment criteria;
providing a menu of available shift selections for the unassigned work shifts for each shift worker;
receiving shift selections based on the plurality of unassigned work shifts from the shift workers;
approving at least one of the shift selections if the shift selection meets at least one selection parameter;
generating a work shift schedule determined based on the shift selections, wherein the work shift schedule includes at least one work shift that is assigned to the shift worker; and
outputting the work shift schedule.

20. A system in accordance with claim 19, further comprising instructions that cause the processor to request an alternative shift selection if the shift selection does not meet the at least one selection parameter.

21. A system in accordance with claim 20, further comprising instructions that cause the processor to:
receive an alternative shift selection;
approve the alternative shift selection if the alternative shift selection meets at least one selection parameter; and
reject the alternative shift selection if the alternative shift selection does not meet the at least one selection parameter.
